(19) United States
(12) Patent Application Publication
(10) Pub. No.: US 2004/0246343 A1
(43) Pub. Date: Dec. 9, 2004

(54) Electronic camera suitable for photography in vertical and horizontal positions

(76) Inventor: Tatsuo Okuda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/883,830

(22) Filed: Jul. 6, 2004

Related U.S. Application Data
(62) Division of application No. 09/617,112, filed on Jul. 14, 2000.

(30) Foreign Application Priority Data
Jul. 21, 1999 (JP) 11-206932

(51) Int. Cl. H04N 5/225

(52) U.S. Cl. 348/207.99

(57) ABSTRACT

An electronic camera has at least one release button disposed in such a position of a camera body that the release button is easy to operate each of when the camera body is held in a horizontal position such that an image-pickup frame is horizontally long and when the camera body is held in a vertical position such that an image-pickup frame is vertically long. An image-pickup processing unit treats image data as that of an image of the vertical position or that of an image of the horizontal position based on a position of the release button operated.

### BACKGROUND OF THE INVENTION

1. Field of the Invention

The present invention generally relates to an electronic camera which performs pickup of an optical image of a subject for photography obtained through a photographing optical system by an image-pickup device, and records it in an electronic recording medium as image data, and, in particular, to an electronic camera suitable for photography in vertical and horizontal positions through which both normal horizontal-position photography in which a photographing frame is horizontally long and vertical-position photography in which the photographing frame is vertically long can be performed properly.

2. Description of the Related Art

Recently, an electronic camera is spreading rapidly, called a digital camera or the like, and performing pickup of an image of a subject for photography by a solid image-pickup device such as a CCD (charge coupled device) image-pickup device, for example, obtaining image data of a still image or a movie image (dynamic image) of the subject for photography, and digitally recording it in an IC (integrated circuit) memory card, a magnetic disk or the like. As the IC memory card, in a case of the electronic camera, a PC card which is an IC card in accordance with PCMCIA (Personal Computer Memory Card International Association) standard is used previously, but, recently, a smart media (trade name), a compact flash (trade name) and so forth which are small and have large storage capacities are being used. As the magnetic disk, although a floppy disc may be used, a recently developed, small-sized magnetic-disk drive employing a hard disk of a very small size equal to the IC memory card is drawing attention.

Generally, the frame of a camera is a rectangular screen horizontally long when the camera is held naturally. A photographing condition in which, as shown in FIG. 1, the above-mentioned horizontally long screen is maintained, a lateral direction, that is, a long-side direction of the camera coincides with the horizontal direction is referred to as a horizontal position, and, is employed frequently for photography of a scenery and group photography. Another photography condition in which the camera is rotated by 90° without changing the photographing optical-axis direction, and, thereby, as shown in FIGS. 2 and 3, the long-side direction of the camera coincides with the vertical direction is referred to as a vertical position, and, is employed for a portrait of a single or few persons.

In a case of a conventional, so-called silver camera using a silver film, and in a case of a full size of 35 mm, when photography is performed in the horizontal position and vertical position as a result of the camera being rotated as mentioned above, an image long along the film transfer direction is formed on the silver film, as shown in FIGS. 1 and 2. Then, after the film is developed, or then is printed on photographic paper, the image is observed in a proper orientation in which the subject for photography is erect, as shown in FIG. 3.

In contrast to this, in the electronic camera, an image obtained by photography is electronic data, and, observation of the photographed image is made using a small liquid-crystal display built therein for a simple method. However, when detailed observation is made, the image data is transferred to a PC (personal computer) or the like, then, the image is displayed on a CRT (cathode ray tube) display, a large-sized liquid-crystal display panel or the like, or is printed through a printer. When the image is printed, it can be treated similarly to a photograph printed on photographic paper. However, when the image is displayed on a screen, it is not convenient to observe the image unless it is erect.

Therefore, although image data taken in the horizontal position such as that shown in FIG. 1 can be observed as an erect image as a result of being disposed in a horizontally long orientation as it is, image data taken in the vertical position such as that shown in FIG. 2 cannot be observed as an erect image unless the orientation of the image is rotated by 90° so as to be disposed in a vertically long orientation as shown in FIG. 3.

In the case of the electronic camera, in order to change the orientation of an image from that set in a process of obtaining image data through photography, it is necessary to perform a rotation operation by image processing. For performing such an image-rotating operation, it is necessary to perform processing of the entirety of the image. Such processing is not performed in the camera, in the related art, in order to reduce an amount of image processing performed in the camera and a time required for the image processing. In such a case, rotation of the image is performed in the PC or the like after the image data is transferred thereto. In order to achieve it, a special software is needed to be installed in the PC or the like previously.

In the electronic camera, inherently, it is possible to set the orientation of an image for each frame at a time of obtaining image data through photography. Therefore, by setting a proper orientation for each frame, it is not necessary to rotate the image by image processing in a subsequent step. However, a problem is how to provide information of orientation of photography to a photographing processing system at a time of photography.

It can be considered that such a device is provided in the electronic camera that the vertical direction is detected using gravitation, then, based thereon, whether the photographing condition is the horizontal position or the vertical position is determined, and, the orientation of the image is determined. However, in some case, the direction in which the gravitation is applied does not precisely correspond to the vertical direction in a case where the camera moves at high speed, or some vibration is applied to the camera. Therefore, precise detection is not easy. Further, a very complicated arrangement is needed for achieving such a system. Furthermore, there is a case where an image taken in the vertical direction is not rotated, and is made to be observed in a horizontally long direction as it is, as shown in FIG. 2, intentionally for a photographic purpose. In such a case, the camera unexpectedly responds to the gravitation, and cannot deal with such a flexible photographic purpose sufficiently.

Alternatively, it can be considered that information of an orientation of photography is input through an operation of a button or the like. However, this makes operations of photography troublesome. Further, when this information is erroneously input due to an erroneous operation, forgetting of an operation, or the like, improper image data is recorded, instead.

On the electronic camera, at a time of photography, zooming operations in a case where a zooming optical system is employed in a photographing optical system, operations for selecting a mode of image-pickup operations, operations of a main switch for turning on/off of power supply for driving the camera are performed arbitrarily in accordance with intentions of a photographer. These zooming operations, mode-switching operations and operations of the main switch are performed not only in a case where the photographer performs photography with the camera held in the horizontal position but also in a case where the photographer performs photography with the camera held in the vertical position. Therefore, it is preferable that an operation unit for the zooming operations, mode-switching operations and operations of the main switch is easy for the photographer to operate not only in the case where the photographer performs photography with the camera held in the horizontal position but also in the case where the photographer performs photography with the camera held in the vertical position.

In a case where the electronic camera has a shape like a flat rectangular parallelepiped in a conventional type, for example, as shown in FIG. 4, zooming switches ZS for the zooming operations include a pair of zooming-in switch and zooming-out switch, and are disposed in the vicinity of a release switch RS on the top surface in a case where a camera body B is held horizontally with an objective surface TL of a photographing optical system disposed on one of the thickness surfaces along the long-side direction faced to a subject for photography, in many cases. When such a type of electronic camera is used, photography in the horizontal position is such as photography performed in a condition in which the camera body B is held horizontally. However, when photography in the vertical position is performed with the camera body B held vertically as a result of the camera body B being rotated by 90°, the zooming switches ZS are located in a problematic position on a flat surface located in a side direction, so that this type of camera is not convenient at a time of photography in the vertical position.

There is another type of electronic camera which has the same shape like a flat rectangular parallelepiped but has a standard condition in which the long-side direction thereof coincides with the vertical direction, and in which position photography in the horizontal position is performed. In such an electronic camera having the standard position of the vertically long condition, as shown in FIG. 5, an objective surface TL of a photographing optical system is disposed on one of the thickness surfaces along the long-side direction of the camera body B, and an eyepiece FD of an optical finder is provided on the other of the thickness surfaces along the long-side direction of the camera body B, in many cases. In such a case, as shown in FIG. 5, the objective surface TL of the photographing optical system and the eyepiece FD of the optical finder are disposed biasedly in the vicinity of the top end so that the camera is easy for a photographer to hold in the vertically long condition. Zooming switches ZS and a mode dial MD which is rotated to be operated and is used as a mode-switching unit are disposed in the vicinity of the eyepiece FD of the optical finder on the other of the thickness surfaces along the long-side direction of the camera body B.

In the case of the form shown in FIG. 5, even in the standard position as it is, operations of the zooming switches ZS and operations of the mode dial MD are not easy for a photographer who is viewing the optical finder FD at a time of photography. Further, in a condition in which the camera is rotated by 90° about the photographing optical axis, operations of the zooming switches ZS and operations of the mode dial MD are not easy to higher degree. Further, in another type of electronic camera in a form similar to that show in FIG. 5 having a photographing optical system TL, an eyepiece of the optical finder FD and a mode dial MD disposed therein, as shown in FIG. 6, the zooming switches ZS may be disposed in the vicinity of the objective surface of the photographing optical system TL on one of flat surfaces on both sides.

As a result of making such an arrangement, in the standard position as it is, operations of the zooming switches ZS becomes easier to some degree for a photographer who is viewing the optical finder FD at a time of photography. However, in a condition in which the camera is rotated by 90° about the photographing optical axis, although the zooming switches ZS are in a condition similar to that shown in FIG. 4, the photographer should operate the zooming switches ZS by the index finger of the left hand. Therefore, this type of camera is not convenient for righty users who are considered as the majority. It can also be considered that this camera is used in a condition in which it is rotated by 90° in the reverse direction. However, in this case, the photographer should operate the zooming switches ZS by the thumb of the right hand. Accordingly, it is also not convenient.

### SUMMARY OF THE INVENTION

The present invention has been devised in consideration of the above-described circumstances, and a first general object of the present invention is to provide an electronic camera which has a simple arrangement, is easy to operate, has a little possibility of being operated erroneously, and is suitable for photography in both the vertical and horizontal positions, for which a proper orientation of an image can be set for each frame at a time of obtaining image data through photography.

A first particular object of the first general object of the present invention is to provide an electronic camera suitable for photography in both the vertical and horizontal positions for which whether the current photography is of the horizontal position or the vertical position can be positively set by a natural operation relating to the photography.

A second particular object of the first general object of the present invention is to provide an electronic camera suitable for photography in both the vertical and horizontal positions for which the orientation of an image can be positively and also properly set by a very simple arrangement.

A third particular object of the first general object of the present invention is to provide an electronic camera suitable for photography in both the vertical and horizontal positions for which the orientation of an image can be positively and also properly set by a simple arrangement made in consideration of remote operation.

A fourth particular object of the first general object of the present invention is to provide an electronic camera suitable for photography in both the vertical and horizontal positions for which the orientation of an image can be positively and also properly set by a further simple arrangement made in consideration of remote operation.

A fifth particular object of the first general object of the present invention is to provide an electronic camera suitable for photography in both the vertical and horizontal positions for which the orientation of an image can be positively and also properly set also at a time of remote control operation by a simple arrangement made in consideration of photography by remote control operation.

A sixth particular object of the first general object of the present invention is to provide an electronic camera suitable for photography in both the vertical and horizontal positions for which whether the current photography is of the horizontal position or the vertical position can be positively set by a natural operation relating to the photography, in a form easy to carry.

A seventh particular object of the first general object of the present invention is to provide an electronic camera suitable for photography in both the vertical and horizontal positions for which whether the current photography is of the horizontal position or the vertical position can be positively set by a natural operation relating to the photography, and, also, in which, also in photography in a special posture, the subject for photography and the field of view of image pickup can be easily checked.

An eighth particular object of the first general object of the present invention is to provide an electronic camera suitable for photography in both the vertical and horizontal positions for which the orientation of an image can be positively and properly set by a natural operation relating to the photography at a time of photography either in the horizontal position or in the vertical position.

A second general object of the present invention is to provide an electronic camera which has a simple arrangement, can be operated easily both in photography in the horizontal position and in photography in the vertical position, has a little possibility of being erroneously operated, and is suitable for photography in the vertical and horizontal positions.

A first particular object of the second general object of the present invention is to provide an electronic camera on which at least one sort of operations of: operations of zooming of a photographing optical system, operations of selecting and setting of a mode of image-pickup operations and operations of turning on/off of power supply for driving respective parts relating to photographing operations can be performed easily by a photographer without disturbance of natural operations relating to photography.

A second particular object of the second general object of the present invention is to provide an electronic camera on which at least one sort of operations of: operations of zooming of a photographing optical system, operations of selecting and setting of a mode of image-pickup operations and operations of turning on/off of power supply for driving respective parts relating to photographing operations can be performed easily by a photographer without disturbance of natural operations relating to photography, and, also, for which a proper orientation of an image can be set for each frame at a time of obtaining image data through photography.

A third particular object of the second general object of the present invention is to provide an electronic camera on which, particularly, operations of zooming of a photographing optical system can be performed easily by a photographer without disturbance of natural operations relating to photography, and, also, for which a proper orientation of an image can be set for each frame at a time of obtaining image data through photography.

A fourth particular object of the second general object of the present invention is to provide an electronic camera on which, particularly, operations of selecting and setting of a mode of image-pickup operations can be performed easily by a photographer without disturbance of natural operations relating to photography, and, also, for which a proper orientation of an image can be set for each frame at a time of obtaining image data through photography.

A fifth particular object of the second general object of the present invention is to provide an electronic camera on which, particularly, operations of turning on/off of power supply for driving respective units relating to photographing operations can be performed easily by a photographer without disturbance of natural operations relating to photography, and, also, for which a proper orientation of an image can be set for each frame at a time of obtaining image data through photography.

A sixth particular object of the second general object of the present invention is to provide an electronic camera on which at least two sorts of operations of: operations of zooming of a photographing optical system, operations of selecting and setting of a mode of image-pickup operations, and operations of turning on/off of power supply for driving respective parts relating to photographing operations can be performed further simply and easily by a photographer without disturbance of natural operations relating to photography, and, also, for which a proper orientation of an image can be set for each frame at a time of obtaining image data through photography.

In order to achieve the above-described objects, an electronic camera suitable for photography in a vertical position and in a horizontal position according to a first aspect of the present invention (corresponding to the above-mentioned first particular object of the first general object) comprises:

a photographing optical system forming an optical image of a subject for photography;

an image-pickup device disposed on a plane on which the optical image of the subject for photography is formed by the photographing optical system and performing pickup of the optical image of the subject for photography;

an image-pickup processing unit performing appropriate processing on image data of the optical image of the subject for photography taken through the image-pickup device and recording it in a recording medium; and

a camera body containing the photographing optical system, image-pickup device and image-pickup processing unit,

wherein:

the electronic camera has at least one release button disposed in at least either one of such a position of the camera body that the release button is easy to operate when the camera body is held in the horizontal position such that an image-pickup frame is horizontally long and such a position of the camera body that the release button is easy to operate when the camera body is held in the vertical position such that an image-pickup frame is vertically long; and

the image-pickup processing unit treats the image data as one of that of the image of the vertical position and that of the image of the horizontal position determined based on the position of the release button operated.

In this arrangement, it is possible to use the information of the release button operated as information indicating an orientation of the image. Accordingly, it is possible to set whether the current photography is of the horizontal position or of the vertical position properly by a natural operation relating to photography. As a result, through a simple arrangement, and without possibility of erroneous operation, it is possible to set the proper orientation of the image for each frame in a process of obtaining the image data through photography, and to set whether the current photography is of the horizontal position or of the ventral position, positively.

According to a second aspect of the present invention (corresponding to the above-mentioned second particular object of the first general object), in the electronic camera according to the first aspect of the present invention, the at least one release button comprises a horizontal-position release button operated when the camera body is held in the horizontal position and a vertical-position release button operated when the camera body is held in the vertical position.

Thereby, it is possible to positively and properly determine an orientation of the image from a very simple operation of merely identifying which one of the two release buttons is operated.

According to a third aspect of the present invention (corresponding to the above-mentioned third particular object of the first general object), the electronic camera according to the second aspect of the present invention further comprises a detachable remote-control device which has a release button operatable in a condition in which the device is loaded in the camera body, and can be loaded in and removed from the camera body, so that the device can be loaded in a position such that the release button is easy to operate when the camera body is held in the vertical position, and the release button of the detachable remote-control device is also used as the vertical-position release button as well as a remote-control release button.

Thereby, it is possible to positively and properly set an orientation of the image through a simple arrangement in that the release button of the remote-control device used for photography in a remote control operation is also used as the vertical-position release button in the condition in which the device is loaded in the camera body.

According to a fourth aspect of the present invention (corresponding to the above-mentioned fourth particular object of the first general object), the electronic camera according to the first aspect of the present invention further comprises a detachable remote-control device which has a release button operatable in a condition in which the device is loaded in the camera body and can be loaded in and removed from the camera body, so that the device can be loaded in the camera body selectively either in a position such that the release button is easy to operate when the camera body is held in the vertical position or in a position such that the release button is easy to operate when the camera body is held in the horizontal position,

the image-pickup processing unit treating the image data as one of that of the image of the vertical position and that of the image of the horizontal position determined based on the position in which the detachable remote-control device is loaded.

Thereby, it is possible to positively and properly set an orientation of the image by determining the orientation of the camera from the loaded position of the remote-control device through the simple arrangement.

According to a fifth aspect of the present invention (corresponding to the above-mentioned fifth particular object of the first general object), the electronic camera according to the first aspect of the present invention further comprises:

a detachable horizontal-position remote-control device which has a release button operatable in a condition in which the device is loaded in the camera body, and can be loaded in and removed from the camera body, so that the device can be loaded in the camera body in a position such that the release button is easy to operate when the camera body is held in the horizontal position; and

a detachable vertical-position remote-control device which has a release button operatable in a condition in which the device is loaded in the camera body, and can be loaded in and removed from the camera body, so that the device can be loaded in the camera body in a position such that the release button is easy to operate when the camera body is held in the vertical position,

the image-pickup processing unit treats the image data as one of that of the image of the vertical position and that of the image of the horizontal position determined based on the detachable remote-control device operated, also on the occasion of a remote control operation.

Thereby, especially on the occasion of photography in a remote control operation, it is possible to positively and properly set an orientation of the image by determining the orientation of the image from the operated remote-control device through the simple arrangement, even on the occasion of a remote control operation.

According to a sixth aspect of the present invention (corresponding to the above-mentioned sixth particular object of the first general object), in the electronic camera according to the first aspect of the present invention, the camera body has a shape like a flat rectangular parallelepiped, has an objective surface of a photographing lens on a thickness surface at one end thereof in a short-side direction and an eyepiece of a optical finder on a thickness surface at the other end, and, has a first release button of the at least one release button for photography in the horizontal position in a flat top surface, and a second release button of the at least one release button for photography in the vertical position in the thickness surface at the one end in the short-side direction in the vicinity of the objective surface of the photographing lens.

In this arrangement, especially in the form like a flat rectangular parallelepiped and thus easy to carry, it is possible to operate the release button disposed in a position where the finger used for operation is naturally located when the camera is held either in the horizontal position or in the vertical position, and to set properly whether the current photography is of the horizontal position or of the vertical position positively, through a natural operation relating to photography.

According to a seventh aspect of the present invention (corresponding to the above-mentioned seventh particular object of the first general object), in the electronic camera according to the first aspect of the present invention, the camera body has a shape like a flat rectangular parallelepiped, has an objective surface of a photographing lens on a thickness surface at one end thereof in a short-side direction and an eyepiece of a optical finder on a thickness surface at the other end, has a display unit in a flat top surface, which is rotatable so as to be openable/closable around an edge on the one end in the short-side direction used as an axis of the rotation, also rotatable around a perpendicular axis of the rotation provided in the vicinity of the center of the axis of the opening/closing rotation, and can be used as an electronic finder.

In this arraignment, it is possible to set properly whether the current photography is of the horizontal position or of the vertical position positively, especially through a natural operation relating to photography, and, also, to easily check the subject for photography and the field of view of image pickup, even in photography in a special posture, using the display unit which can be tilted either in the horizontal position or in the vertical position as an electronic finder.

An electronic camera suitable for photography in a vertical position and in a horizontal position according to an eighth aspect of the present invention (corresponding to the above-mentioned eighth particular object of the first general object) comprises:

a photographing optical system forming an optical image of a subject for photography;

an image-pickup device disposed on a plane on which the optical image of the subject for photography is formed by the photographing optical system and performing pickup of the optical image of the subject for photography;

an image-pickup processing unit performing appropriate processing on image data of the optical image of the subject for photography taken through the image-pickup device and recording it in a recording medium; and

a camera body containing the photographing optical system, image-pickup device and image-pickup processing unit,

wherein:

a photographing unit including the photographing optical system and an optical finder is provided in the camera body in a manner such that the photographing unit is rotatable by 90° around an axis perpendicular to an optical axis of the photographing optical system, and photography is performed in a condition in which the photographing unit is rotated by the 90°;

the electronic camera has at least one release button disposed in such a position of the camera body that the release button is easy to operate each of when the camera body is held in the horizontal position such that an image-pickup frame is horizontally long and when the camera body is held in the vertical position such that an image-pickup frame is vertically long; and

the image-pickup processing unit treats the image data as one of that of the image of the vertical position and that of the image of the horizontal position determined based on the position of the release button operated.

Thereby, especially, the camera is easy to hold on the occasion of photography either in the horizontal position or in the vertical position, and, it is possible to set an orientation of the image properly and positively.

An electronic camera suitable for photography in a vertical position and in a horizontal position according to a ninth aspect of the present invention (corresponding to the above-mentioned first particular object of the second general object) comprises:

a photographing optical system forming an optical image of a subject for photography;

an image-pickup device disposed on a plane on which the optical image of the subject for photography is formed by the photographing optical system and performing pickup of the optical image of the subject for photography;

an image-pickup processing unit performing appropriate processing on image data of the optical image of the subject for photography taken through the image-pickup device and recording it in a recording medium; and

a camera body approximately like a rectangular parallelepiped, containing the photographing optical system, image-pickup device and image-pickup processing unit,

wherein:

the electronic camera has at least one of a zooming operation part for causing the photographing optical system to perform a zooming operation, a mode selecting operation part for selectively setting a mode of image-pickup operations and a main switch operation part for turning on and off of driving power supply to respective parts relating to a photographing operation, disposed in a position(s) in which it is (they are) easy to operate either when the camera body is held in the horizontal position such that an image-pickup frame is horizontally long or when the camera body is held in the vertical position such that an image-pickup frame is vertically long, and in a form(s) such that it (they) can be simply operated either when the camera body is held in the horizontal position or when the camera body is held in the vertical position.

In this arrangement, it is possible to perform at least one sort of operations of operations of zooming of a photographing optical system, operations of selecting and setting of an image-pickup operating mode and operations of turning on/off power supply for driving respective parts relating to photographing operations easily without disturbance of natural operations relating to photography, the camera is easy to operate on the occasion of photography either in the horizontal position or in the vertical position, through the simple arrangement, and it is possible to reduce a possibility of erroneous operation.

According to a tenth aspect of the present invention (corresponding to the above-mentioned second particular object of the second general object), the electronic camera according to the ninth aspect of the present invention further comprises a horizontal-position release button and a vertical-position release button disposed in positions such that they are easy to operate when the camera body is held in the horizontal position and when the camera body is held in the vertical position, respectively,

the image-pickup processing unit treating the image data as one of that of the image of the vertical position and that of the image of the horizontal position determined based on the position of the release button operated.

In this arrangement, it is possible to perform at least one sort of operations of operations of zooming of a photographing optical system, operations of selecting and setting of image-pickup operating modes and operations of turning on/off of power supply for driving respective units relating to photographing operations easily without disturbance of natural operations relating to photography, and, it is possible to set the proper orientation of the image for each frame in a process of obtaining the image data through photography.

An electronic camera suitable for photography in a vertical position and in a horizontal position according to an eleventh aspect of the present invention (corresponding to the above-mentioned third particular object of the second general object) comprises:

a photographing optical system forming an optical image of a subject for photography;

an image-pickup device disposed on a plane on which the optical image of the subject for photography is formed by the photographing optical system and performing pickup of the optical image of the subject for photography;

an image-pickup processing unit performing appropriate processing on image data of the optical image of the subject for photography taken through the image-pickup device and recording it in a recording medium; and

a camera body approximately like a rectangular parallelepiped, containing the photographing optical system, image-pickup device and image-pickup processing unit,

wherein:

an objective surface of the photographing optical system is disposed in one of thickness surfaces along a long-side direction of the camera body, an eyepiece of an optical finder is disposed in the other thereof, a release button for photography in the horizontal position in a flat top surface and a release button for photography in the vertical position in the one of the thickness surfaces along the long-side direction of the camera body in the vicinity of the objective surface of the photographing optical system, and, the image-pickup processing unit treats the image data as one of that of the image of the vertical position and that of the image of the horizontal position determined based on the position of the release button operated, and

the electronic camera further comprises a zooming operation part provided in the camera body in the other of the thickness surfaces along the ling-side direction in the vicinity of the eyepiece of the optical finder in a manner such that an operating part thereof projects from at least one of edges of both the flat surfaces and the thickness surface, for causing the photographing optical system to perform a zooming operation.

In this arrangement, it is possible to perform operations of zooming of the photographing optical system easily without disturbance of natural operations relating to photography, and, it is possible to set the proper orientation of the image for each frame in a process of obtaining the image data through photography.

An electronic camera suitable for photography in a vertical position and in a horizontal position according to a twelfth aspect of the present invention (corresponding to the above-mentioned fourth particular object of the second general object) comprising:

a photographing optical system forming an optical image of a subject for photography;

an image-pickup device disposed on a plane on which the optical image of the subject for photography is formed by the photographing optical system and performing pickup of the optical image of the subject for photography;

an image-pickup processing unit performing appropriate processing on image data of the optical image of the subject for photography taken through the image-pickup device and recording it in a recording medium; and

a camera body approximately like a rectangular parallelepiped, containing the photographing optical system, image-pickup device and image-pickup processing unit,

wherein:

an objective surface of the photographing optical system is disposed in one of thickness surfaces along a long-side direction of the camera body, an eyepiece of an optical finder is disposed in the other thereof, a release button for photography in the horizontal position in a flat top surface and a release button for photography in the vertical position in the one of the thickness surfaces along the long-side direction of the camera body in the vicinity of the objective surface of the photographing optical system, and, the image-pickup processing unit treats the image data as one of that of the image of the vertical position and that of the image of the horizontal position determined based on the position of the release button operated, and

the electronic camera further comprises a mode selecting operation part provided in the camera body in the other of the thickness surfaces along the ling-side direction in the vicinity of the eyepiece of the optical finder in a manner such that an operating part thereof projects from at least one of edges of both the flat surfaces and the thickness surface, for selectively setting a mode of image-pickup operations.

In this arrangement, it is possible to perform operations of selecting and setting of image-pickup operating modes easily without disturbance of natural operations relating to photography, and, it is possible to set the proper orientation of the image for each frame in a process of obtaining the image data through photography.

An electronic camera suitable for photography in a vertical position and in a horizontal position according to a thirteenth aspect of the present invention (corresponding to the above-mentioned fifth particular object of the second general object) comprises:

a photographing optical system forming an optical image of a subject for photography;

an image-pickup device disposed on a plane on which the optical image of the subject for photography is formed by the photographing optical system and performing pickup of the optical image of the subject for photography;

an image-pickup processing unit performing appropriate processing on image data of the optical image of the subject for photography taken through the image-pickup device and recording it in a recording medium; and

a camera body approximately like a rectangular parallelepiped, containing the photographing optical system, image-pickup device and image-pickup processing unit,

wherein:

an objective surface of the photographing optical system is disposed in one of thickness surfaces along a long-side direction of the camera body, an eyepiece of an optical finder is disposed in the other thereof, a release button for photography in the horizontal position in a flat top surface and a release button for photography in the vertical position in the one of the thickness surfaces along the long-side direction of the camera body in the vicinity of the objective surface of the photographing optical system, and, the image-pickup processing unit treats the image data as one of that of the image of the vertical position and that of the image of the horizontal position determined based on the position of the release button operated, and

the electronic camera further comprises a main switch provided in the camera body in the other of the thickness surfaces along the ling-side direction in the vicinity of the eyepiece of the optical finder in a manner such that an operating part thereof projects from at least one of edges of both the flat surfaces and the thickness surface, for turning on and off of driving power supply to respective parts relating to a photographing operation.

In this arrangement, it is possible to perform operations of turning on/off power supply for driving respective units relating to photographing operations easily without disturbance of natural operations relating to photography, and, it is possible to set the proper orientation of the image for each frame in a process of obtaining the image data through photography.

An electronic camera suitable for photography in a vertical position and in a horizontal position according to a fourteenth aspect of the present invention (corresponding to the above-mentioned sixth particular object of the second general object) comprises:

a photographing optical system forming an optical image of a subject for photography;

an image-pickup device disposed on a plane on which the optical image of the subject for photography is formed by the photographing optical system and performing pickup of the optical image of the subject for photography;

an image-pickup processing unit performing appropriate processing on image data of the optical image of the subject for photography taken through the image-pickup device and recording it in a recording medium; and

a camera body approximately like a rectangular parallelepiped, containing the photographing optical system, image-pickup device and image-pickup processing unit,

wherein:

an objective surface of the photographing optical system is disposed in one of thickness surfaces along a long-side direction of the camera body, an eyepiece of an optical finder is disposed in the other thereof, a release button for photography in the horizontal position in a flat top surface and a release button for photography in the vertical position in the one of the thickness surfaces along the long-side direction of the camera body in the vicinity of the objective surface of the photographing optical system, and, the image-pickup processing unit treats the image data as one of that of the image of the vertical position and that of the image of the horizontal position determined based on the position of the release button operated, and

the electronic camera further comprises at least two of a zooming operation part for causing the photographing optical system to perform a zooming operation, a mode selecting operation part for selectively setting a mode of image-pickup operations and a main switch operation part for turning on and off of driving power supply to respective parts relating to a photographing operation, provided in the camera body in the other of the thickness surfaces along the ling-side direction in the vicinity of the eyepiece of the optical finder in a manner such that they coaxially project from at least one of edges of both the flat surfaces, and the thickness surface.

In this arrangement, it is possible to perform at least two sorts of operations of operations of zooming of a photographing optical system, operations of selecting and setting of image-pickup operating modes and operations of turning on/off of power supply for driving respective units relating to photographing operations further simply and easily, and, it is possible to set the proper orientation of the image for each frame in a process of obtaining the image data through photography.

Other objects and further features of the present invention will become more apparent from the following detailed description when read in conjunction with the accompanying drawings.

### BRIEF DESCRIPTION OF THE DRAWINGS

FIG. 1 typically shows an example of a photographed image in a horizontal position in an electronic camera in the related art;

FIG. 2 typically shows an example of a photographed image in a vertical position in the electronic camera in the related art;

FIG. 3 typically shows the photographed image in a condition in which the example of the photographed image shown in FIG. 2 is rotated by 90° to a correct image;

FIG. 4 shows a perspective view of an electronic camera in the related art in the horizontal position viewed from the front direction;

FIG. 5 shows a perspective view of an electronic camera in the related art in the vertical position viewed from the rear direction;

FIG. 6 shows a perspective view of an electronic camera in the related art in the vertical position viewed from the rear direction;

FIG. 7 shows a perspective view of an electronic camera suitable for photography in the vertical position and in the horizontal position in a first embodiment of the present invention, viewed from a side of an incidence surface of a photographing lens in the horizontal position in a condition in which a liquid-crystal-display monitor unit (LCD monitor unit) is closed;

FIG. 8 shows a perspective view of the electronic camera shown in FIG. 7 viewed from a side of an eyepiece of an optical finder in the horizontal position in the condition in which the LCD monitor unit is closed;

FIG. 9 shows a perspective view of the electronic camera shown in FIG. 7, viewed from the side of the eyepiece of the optical finder in the horizontal position in the condition in which the LCD monitor unit is raised;

FIG. 10 shows a perspective view of the electronic camera shown in FIG. 7, viewed from the side of the incidence surface of the photographing lens in the horizontal position in the condition in which the LCD monitor unit is raised;

FIG. 11 shows a perspective view of the electronic camera shown in FIG. 7, viewed from the side of the eyepiece of the optical finder in the vertical position in the condition in which the LCD monitor unit is raised;

FIG. 12 is a block diagram showing a configuration of an electronic-circuit system of the electronic camera shown in FIG. 7;

FIG. 13 shows a perspective view of an electronic camera suitable for photography in the vertical position and in the horizontal position in a second embodiment of the present invention, in a condition in which a photographing unit is contained in a camera body, viewed from a rear side;

FIG. 14 shows a perspective view of the electronic camera shown in FIG. 13, in the condition in which the photographing unit is contained in the camera body, viewed from a front side;

FIG. 15 shows a perspective view of the electronic camera shown in FIG. 13, in the horizontal position in a condition in which the photographing unit is raised from the camera body, viewed from the front side, that is, a side of an incidence surface of a photographing lens;

FIG. 16 shows a perspective view of the electronic camera shown in FIG. 13, in the vertical position in the condition in which the photographing unit is raised from the camera body, viewed from the rear side, that is, a side of an eyepiece of an optical finder and a screen of an LCD monitor;

FIG. 17 is a block diagram showing a configuration of an electronic-circuit system of the electronic camera shown in FIG. 13;

FIG. 18 shows a perspective view of an electronic camera suitable for photography in the vertical position and in the horizontal position in a third embodiment of the present invention, held in the horizontal position, viewed from a front side, that is, a side of an incidence surface of a photographing lens;

FIG. 19 shows a perspective view of the electronic camera shown in FIG. 18, held in the vertical position, viewed from the front side;

FIG. 20 shows a perspective view of a detachable remote-control device obtained as a result of a release button and the vicinity thereof of the electronic camera shown in FIG. 7 being made to be detachable;

FIG. 21 shows a perspective view of a detachable remote-control device obtained as a result of a vertical/horizontal-position instructing operation unit being further provided in the detachable remote-control device shown in FIG. 20;

FIG. 22 shows a plan view of an electronic camera suitable for photography in the vertical position and in the horizontal position in a fourth embodiment of the present invention, in a condition in which a liquid-crystal-display monitor unit (LCD monitor unit) is closed, viewed from a side of a top surface;

FIG. 23 shows a rear elevational view of the electronic camera shown in FIG. 22, in the condition in which the LCD monitor unit is closed, viewed from a side of an eyepiece of an optical finder;

FIG. 24 shows a bottom view of the electronic camera shown in FIG. 22, in the condition in which the LCD monitor unit is closed, viewed from a side of a bottom surface;

FIG. 25 shows a portion-including a zooming lever and a mode dial of the electronic camera shown in FIG. 22 in detail;

FIG. 26 shows a portion including a zooming lever, a mode dial and a main switch of the electronic camera shown in FIG. 23 in detail;

FIG. 27 shows a portion including an auxiliary zooming lever and a mode dial of the electronic camera shown in FIG. 24 in detail; and

FIG. 28 is a block diagram shown a configuration of an electronic-circuit system of the electronic camera shown in FIG. 22.

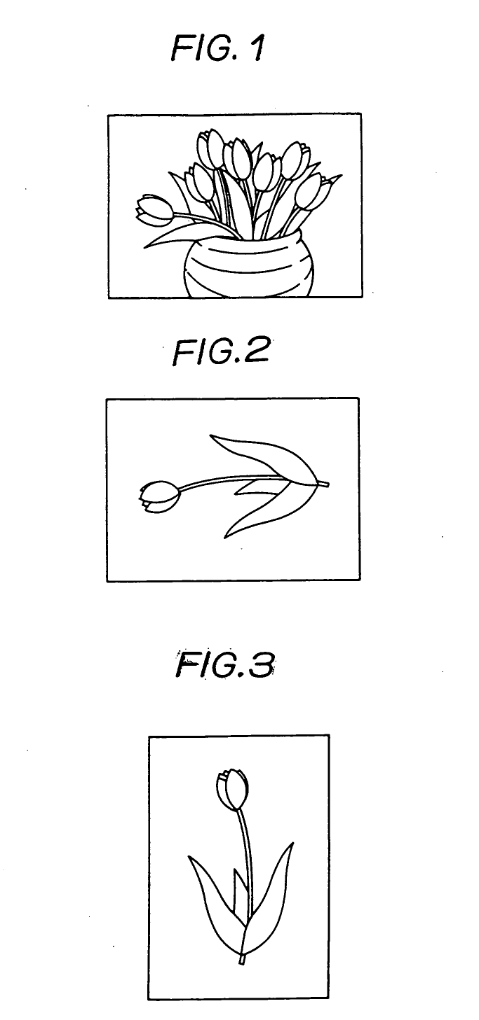

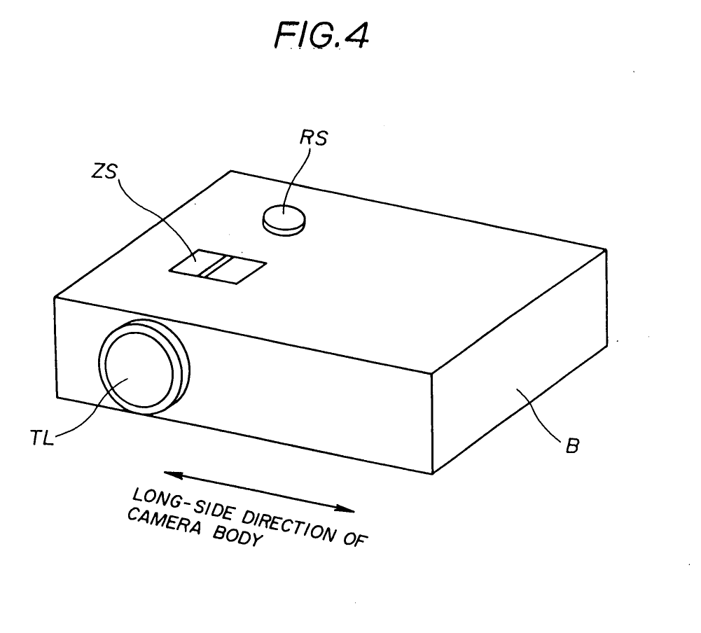

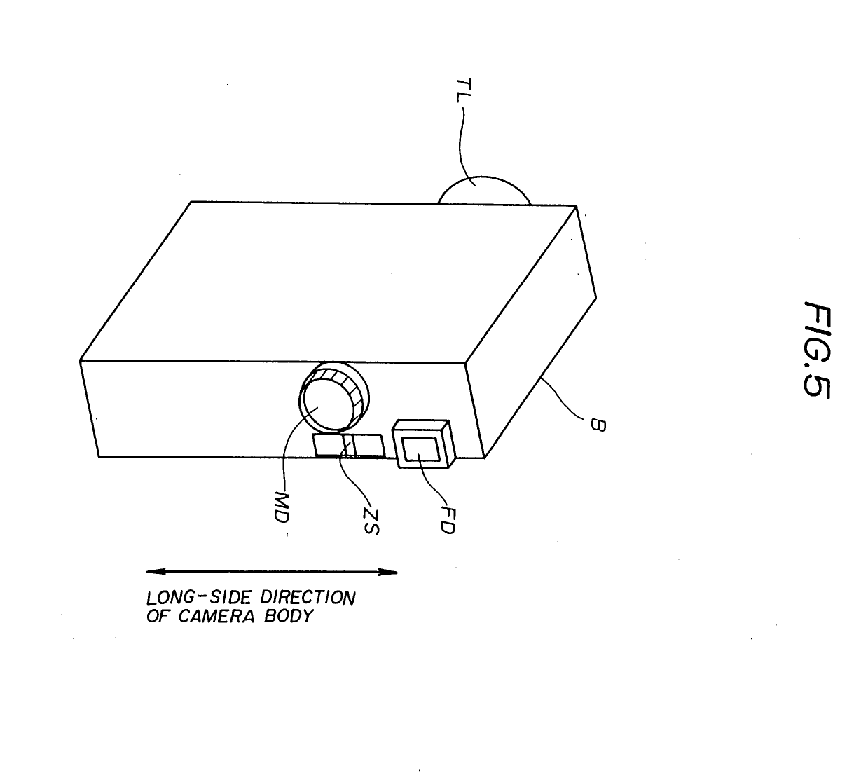

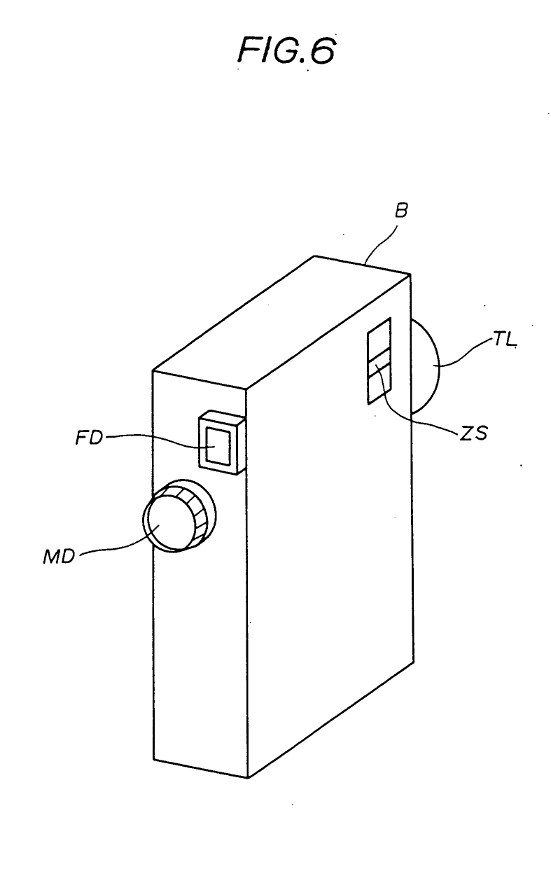

### DETAILED DESCRIPTION OF THE PREFERRED EMBODIMENTS

Making reference to figures, electronic cameras suitable for photography in the vertical and horizontal positions in embodiments of the present invention will now be described.

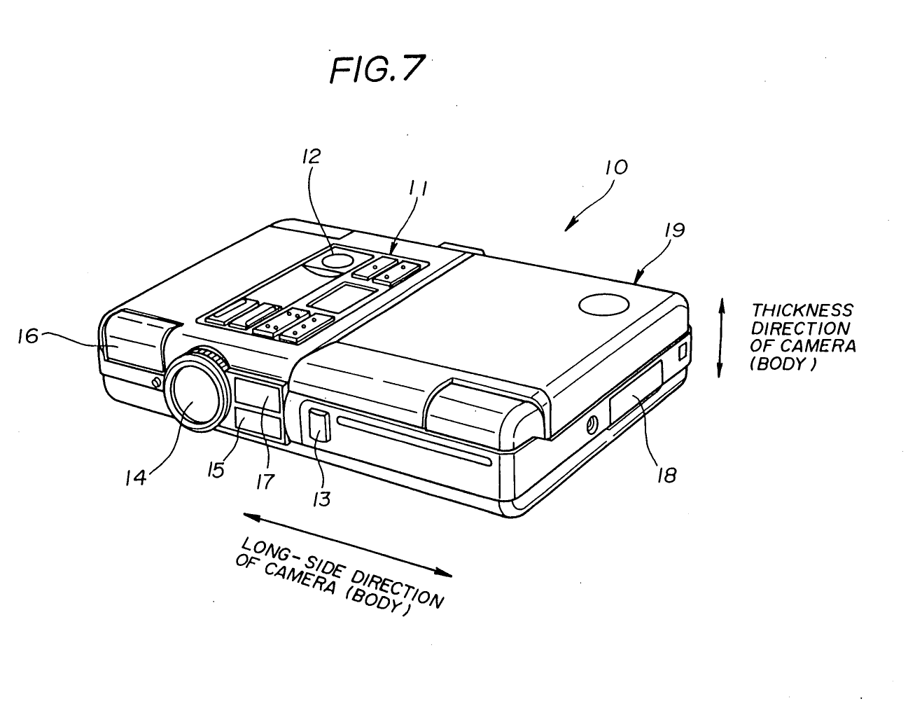

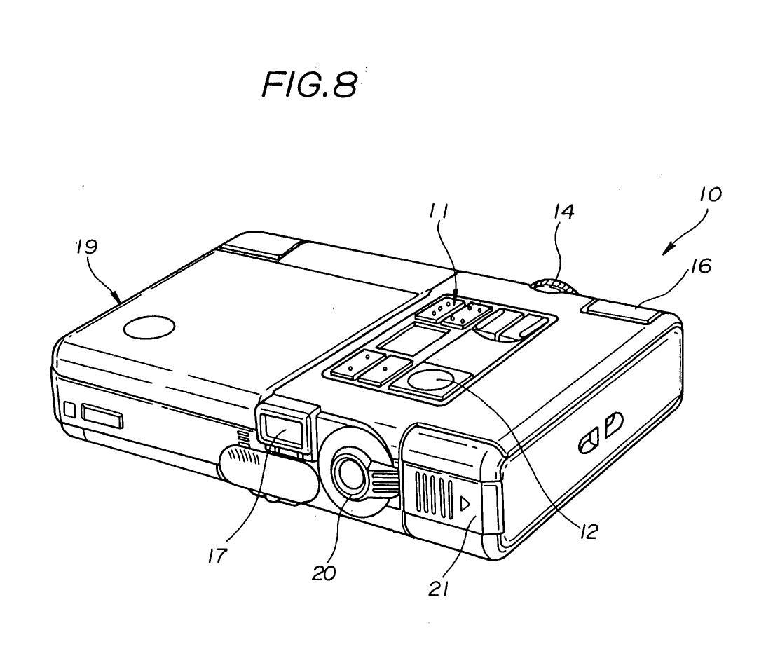

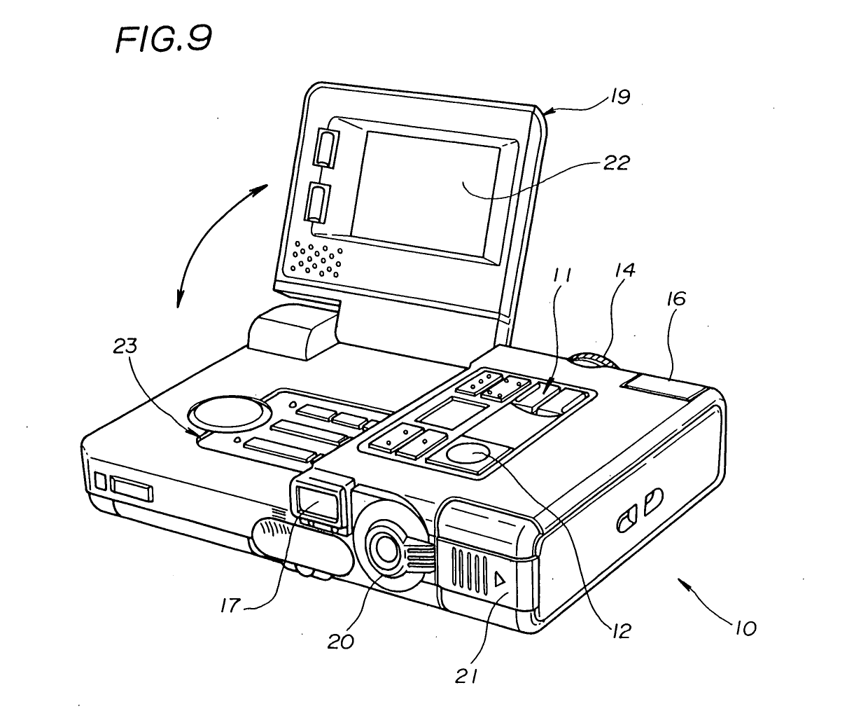

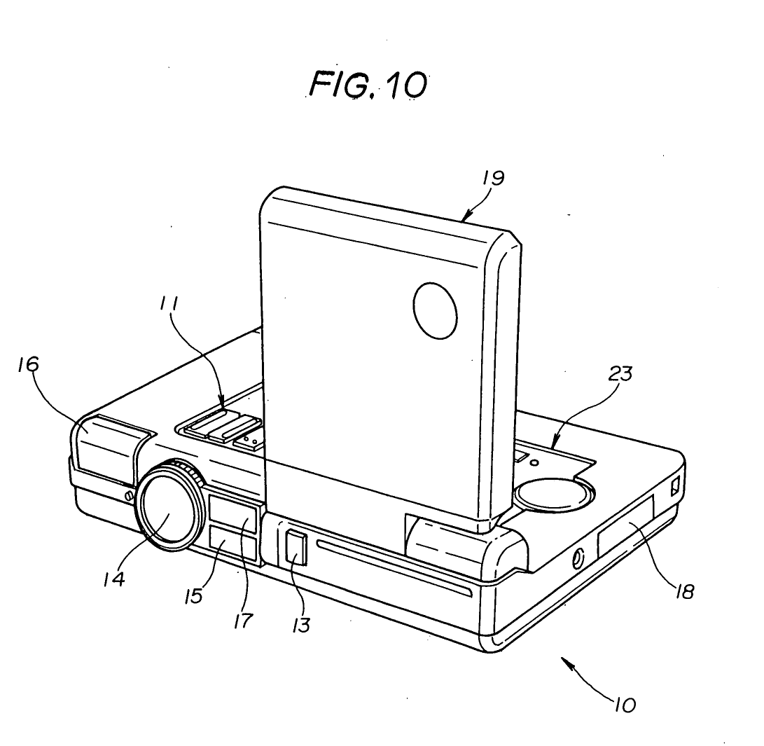

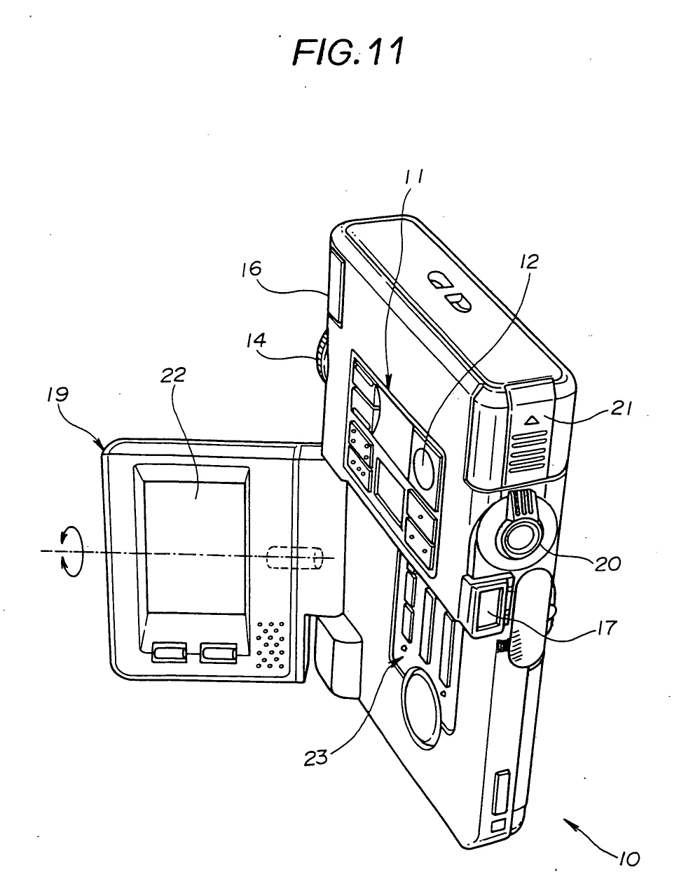

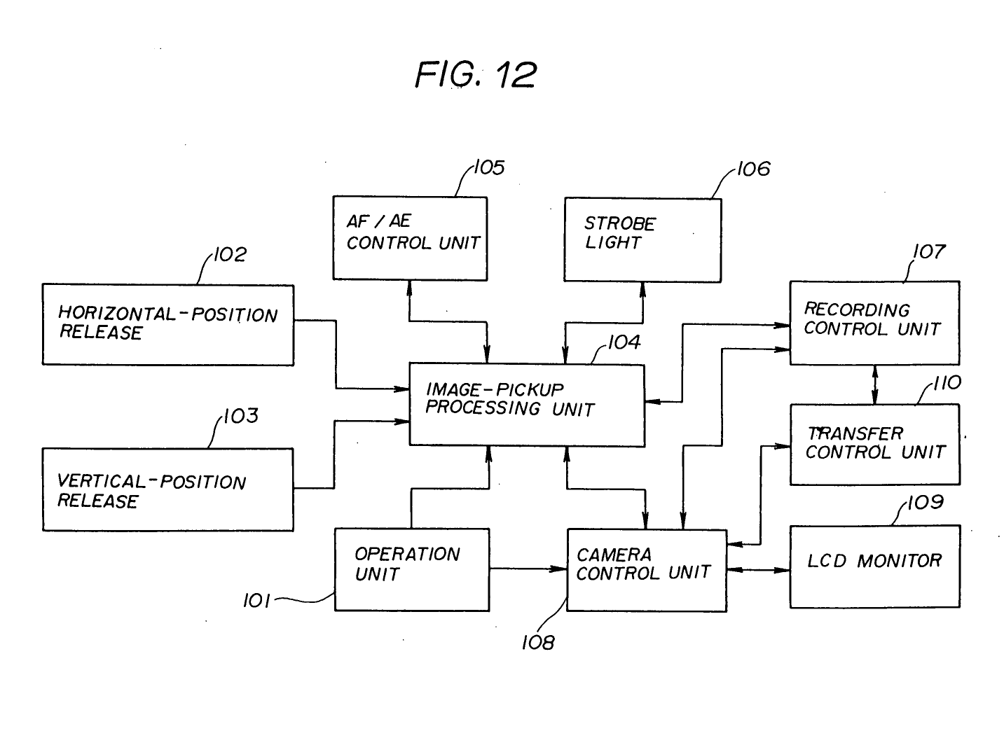

FIGS. 7 through 12 show a configuration of an electronic camera suitable for photography in the vertical and horizontal positions in a first embodiment of the present invention. FIG. 7 shows a perspective view of the electronic camera viewed from a side of an incidence surface of a photographing lens in the horizontal position in a condition in which a liquid-crystal-display monitor unit (referred to as an ‘LCD monitor unit’, hereinafter) is closed. FIG. 8 shows a perspective view of the electronic camera viewed from a side of an eyepiece of an optical finder in the horizontal position in the condition in which the LCD monitor unit is closed. FIG. 9 shows a perspective view of the electronic camera viewed from the side of the eyepiece of the optical finder in the horizontal position in the condition in which the LCD monitor unit is raised. FIG. 10 shows a perspective view of the electronic camera viewed from the side of the incidence surface of the photographing lens in the horizontal position in the condition in which the LCD monitor unit is raised. FIG. 11 shows a perspective view of the electronic camera viewed from the side of the eyepiece of the optical finder in the vertical position in the condition in which the LCD monitor unit is raised. FIG. 12 shows a configuration of an electronic-circuit system of the electronic camera.

The electronic camera 10 shown in FIGS. 7 through 11 has a camera body having a shape like a flat rectangular parallelepiped as a whole, and includes a photographing operation unit 11, a horizontal-position release button 12, a vertical-position release button 13, the photographing lens 14, an AF (autofocusing) window 15, a strobe-light light-emiitting unit 16, the optical finder 17, a connector unit 18, the LCD monitor unit 19, a mode operation unit 20, a battery container 21, an LCD screen 22 and a main operation unit 23.

The photographing operation unit 11 includes operation buttons for a photographer to perform various operations relating to photography and so forth, and, is disposed in the top surface approximately at the center thereof of the camera in the horizontal position, that is, in the left side surface viewed from a photographer of the electronic camera in the vertical position. As a result, the photographing operation unit 11 can be easily operated by the photographer either in the horizontal position in which the photographer holds the camera approximately horizontally in a condition in which the long-side direction of the camera coincides with the horizontal direction and the thickness direction of the camera coincides with the vertical direction, or in the vertical position in which the photographer holds the camera approximately vertically in a condition in which the long-side direction of the camera coincides with the vertical direction and the thickness direction of the camera coincides with the horizontal direction.

In FIG. 8, the horizontal-position release button 12 is disposed in the top surface approximately in the center but to the right thereof of the camera body as a part of or in the vicinity of the photographing operation unit 11, and can be operated by the index finger of the right hand of a photographer. The vertical-position release button 13 is, in FIG. 7, disposed on the right side of and in the vicinity of the objective incidence surface of the photographing lens 14 in the above-described horizontal position, that is, is disposed, when a photographer holds the camera in the vertical position by the right hand, below and in the vicinity of the photographing lens 14 so that the photographer can operate it by the index finger of the right hand.

The photographing lens 14 is provided in a manner such that the objective incidence surface thereof is exposed on one side surface (thickness surface) along the long-side direction of the camera body having the shape like a flat rectangular parallelepiped, and the photographing optical axis thereof is directed in the short-side direction of the camera body. The AF window 15 is a transmission/reception window for transmitting and receiving a focusing beam for focusing by active autofocusing, for example, and is provided between the objective incidence surface of the photographing lens 14 and the vertical-position release button 13, that is, in this case, at a lower position in the horizontal position shown in FIG. 7.

The strobe-light light-emitting unit 16 is disposed in the vicinity of the objective incidence surface of the photographing lens 14, that is, in this case, on the left side in the horizontal position shown in FIG. 7.

The optical finder 17 is provided in a manner such that the objective incidence surface thereof is exposed on the above-mentioned one side surface along the long-side direction between the objective incidence surface of the photographing lens 14 and the vertical-position release button 13, that is, in this case, at an upper position in the horizontal position, and, the eyepiece thereof is exposed on the other side surface opposite to the above-mentioned one side surface. That is, the objective incidence surface of the optical finder 17 and AF window 15 are arranged vertically in the horizontal position, and are arranged between the objective incidence surface of the photographing lens 14 and the vertical-position release button 13.

The connector unit 18 has a signal line connected thereto for transmitting/receiving information to/from an external apparatus, for example, for transferring image data obtained through photography and stored in the camera to an external PC or the like. It is preferable that the connector unit 18 is provided with an openable/closable lid for a dust-proof purpose.

As shown in FIG. 9, the LCD monitor unit 19 is provided in a manner such that it can be set in a desired angular position as a result of opening/closing operations being performed as a result of it being rotated around the edge (rotation axis) of the top surface on the side of a subject for photograph in the horizontal position, and, in a condition in which it is closed, the LCD screen 22 comes into contact with the camera body and can be hidden. Further, this LCD monitor unit 19 is provided in a manner such that, in a condition in which it is raised so as to expose the LCD screen 22, as shown in FIG. 11, it can be rotated around an axis perpendicular to the rotation axis of the above-mentioned opening/closing operations. Accordingly, it is possible to move the LCD monitor unit 19 in a manner such that, in the condition in which the LCD monitor unit 19 is raised, as shown in FIG. 11, it is rotated around the axis perpendicular to the rotation axis of the opening/closing operations, thus the LCD screen 22 is reversed, and, thereby, the LCD screen 22 is exposed on the top surface of the camera body even in a condition in which the LCD monitor unit 19 is closed.

The mode operation unit 20 is, for example, disposed in the side surface in which the eyepiece of the optical finder 17 is disposed, adjacent to this eyepiece, and, is provided with a mode dial for a photographer to select a mode of an operation, a main switch for the photographer to turn on and off a main power source, a zooming lever in a case where the photographing lens 14 is a zoom lens, and so forth coaxially. The battery container 21 has an openable/closable, battery inserting/removing hole disposed in the side surface in which the eyepiece of the optical finder 17 is disposed, at a corner thereof, for example, and, through the battery inserting/removing hole, a battery can be inserted into/removed from the battery container 21. The LCD screen 22 is a display surface of the LCD, and, as described above, is disposed in one surface of the LCD monitor unit 19. The main operation unit 23 is an operation unit for a user to perform various operations therethrough such as photography, reproduction and display of recorded image data, and is provided at a portion of the camera body, which portion is covered by the LCD monitor unit 19 when the LCD monitor unit 19 is closed.

The electronic-circuit system of the above-described electronic camera 10 has an arrangement shown in FIG. 12. This electronic-circuit system includes an operation unit 101, a horizontal-position release 102, a vertical-position release 103, an image-pickup processing unit 104, an AF/AE (automatic exposure) control unit 105, a strobe light 106, a recording control unit 107, a camera control unit 108, an LCD monitor 109 and a transfer control unit 110.

The operation unit 101 supplies operation information input as a result of the photographing operation unit 11, mode operation unit 20 and main operation unit 23, shown in FIGS. 7 through 11, being operated by a user, to the image-pickup processing unit 104 and camera control unit 108. The horizontal-position release 102 supplies release information input as a result of the horizontal-position release button 12 being operated by a photographer, to the pickup processing unit 104 and causes it to perform image pickup in a manner such that image data obtained through photography is treated as image data of the horizontal position. The vertical-position release 102 supplies release information input as a result of the vertical-position release button 13 being operated by a photographer, to the image-pickup processing unit 104 and causes it to perform image pickup in a manner such that image data thus obtained is treated as image data of the vertical position.

In response to the release information supplied from the horizontal release 102 and vertical release 103 in accordance with operations performed by a photographer on the horizontal-position release button 12 and vertical-position release button 13, the image-pickup processing unit 104 causes the AF/AE control unit 105, strobe light 106, recording control unit 107, camera control unit 108 and so forth, to operate appropriately based on a photographing mode (mode of image-pickup operations) which is set at the time, and to perform AF and AE control, control of light emitting of the strobe light 106, control of recording image data in a recording medium, and other controls of camera operations appropriately, selectively, as the need arises, and thus, performs image-pickup operations. The image-pickup processing unit 104 obtains image-pickup data as image data of the horizontal position or image data of the vertical position, or processes image data obtained through photography in a manner such that the image data is treated as image data of the horizontal position or image data of the vertical position, in accordance with whether the release information is supplied by the horizontal-position release 102 or vertical-position release 103, that is, whether the horizontal-position release button 12 or vertical-position release button 13 is operated by the photographer.

The AF/AE control unit 105 operates, in conjunction with the image-pickup processing unit 104, and performs AF control based on focusing information obtained from transmitting/receiving the focusing beam through the AF window 15 in accordance with the active autofocusing, for example. Further, the AF/AE control unit 105 obtains information of quantity of light of the subject for photography from a light-receiving device provided in the optical system such as the photographing lens 14, optical finder 17 and so forth, or provided separately, or an image-pickup device in the image-pickup processing unit 104, and performs proper exposure control based thereon.

The strobe light 106 is controlled by the image-pickup processing unit 104, and operates when it is necessary from an AE-control point of view of the AF/AE control unit 105, or when it is instructed manually through the operation unit 101, and causes the strobe-light light-emitting unit 16 to emit light. The recording control unit 107 writes image data obtained through image pickup by the image-pickup processing unit 104 in the recording medium. The camera control unit 108 controls the image-pickup processing unit 104 in accordance with the operation information from the operation unit 101, so as to cause it to perform photography, display through the LCD monitor 109 an image of a subject for photography before or on photography, or reproduce and display an image of a subject photographed and stored in the recording medium or the like. The LCD monitor 109 is controlled by the camera control unit 108, displays an image of a subject before or on photography obtained through the image-pickup device of the image-pickup processing unit 104 or displays an image of a subject stored in and reproduced from the recording medium or the like, on the LCD screen 22 of the LCD monitor unit 19.

Based on control by the camera control unit 108 in accordance with the operation information from the operation unit 101, the transfer control unit 110 reads image data stored in the recording medium through the recording control unit 107, and transfers it selectively or collectively to an external PC or the like.

Operations and functions of the above-described electronic camera 10 will now be described concretely.

First, when it is carried, as shown in FIGS. 7 and 8, the LCD monitor unit 19 is closed in a condition in which the LCD screen 22 faces inwardly, so that it has the shape like a flat rectangular parallelepiped. In this condition, the electronic camera 10 is not unwieldy and has a few uneven portions. Accordingly, it is very easy to carry, and, also, the LCD screen 22 and so forth are positively protected. When photography is performed only through the optical finder 17 without employing an electronic finder of the LCD monitor unit 19, it is possible to perform photography by turning on the main switch of the mode operation unit 20 in this condition.

When performing photography in the horizontal position, the photographer holds the electronic camera 10 horizontally in such a manner that the objective incidence surface of the photographing lens 14 is faced to a subject for photography, the strobe-light light-emitting unit 16 is located to the upper right of the objective incidence surface of the photographing lens 14 viewed from the photographer, and the LCD monitor unit 19 is located in the top surface, as shown in FIGS. 7 and 8. In this condition, the horizontal-position release button 12 is located at a portion of the top surface somewhat on this side and to the right in the center thereof where the index finger of the right hand is naturally located. Therefore, as shown in FIG. 7, it is possible to perform photography in the horizontal position with the photographer's operations which are not unnatural. At this time, because the photographing operation unit 11 is located on the top surface at the center thereof, and the mode operation unit 20 is located on the side surface on this side to the right of and beside the eyepiece of the optical finder 17, any thereof can be easily operated.

Further, at this time, the main operation unit 23 is hidden under the LCD monitor unit 19, and the vertical-position release button 13 is located on the subject-side side surface on the left side of the photographing lens 14 viewed from the photographer. Accordingly, there is little possibility that any thereof is erroneously operated.

On the occasion of photography in the vertical position, the photographer holds the electric camera 10 vertically in a manner such that the objective incidence surface of the photographing lens 14 is faced to a subject for photography, the strobe-light light-emitting unit 16 is located to the upper left of the objective incidence surface of the photographing lens 14 viewed from the photographer, and the LCD monitor unit 19 is located in the left surface. In this condition, the vertical-position release button 13 is located at a portion of the front surface somewhat to the lower right approximately in the center thereof where the index finger of the right hand is naturally located. Accordingly, it is possible to perform photography in the vertical position with the photographer's operations which are not unnatural. At this time, it is preferable that the left hand holds the top surface and the left edge thereof of the electronic camera 10.

Because the photographing operation unit 11 is located in the left surface at the center thereof, and the mode operation unit 20 is located on the side surface on this side above the eyepiece of the optical finder 17, any thereof can be easily operated. The main operation unit 23 is hidden under the LCD monitor unit 19, and the horizontal-position release button 12 is located in the left surface viewed from the photographer. Accordingly, there is little possibility that any thereof is erroneously operated.

On the occasion of photography in the horizontal position when the LCD monitor unit 19 is used as the electronic finder, photography is performed in a condition in which the LCD monitor unit 19 is raised, as shown in FIGS. 9 and 10. At this time, it is possible to tilt the LCD screen 22 to a position such that it is easy to view, depending on a photographing posture and/or a condition of external light.

Similarly to the above-described condition in which the LCD monitor unit 19 is closed, the photographer holds the electronic camera 10 horizontally in such a manner that the objective incidence surface of the photographing lens 14 is faced to a subject for photography, the strobe-light light-emitting unit 16 is located to the upper right of the objective incidence surface of the photographing lens 14 viewed from the photographer, and the LCD monitor unit 19 is located in the top surface. Also in this condition, the horizontal-position release button 12 is located at a portion of the top surface somewhat on this side and to the right in the center thereof where the index finger of the right hand is naturally located. Therefore, it is possible to perform photography in the horizontal position with the photographer's operations which are not unnatural. At this time, because the photographing operation unit 11 is located in the top surface at the center thereof, and the mode operation unit 20 is located in the side surface on this side to the right of and beside the eyepiece of the optical finder 17, any thereof can be easily operated. Further, at this time, the vertical-position release button 13 is located in the subject-side side surface on the left side of the photographing lens 14 viewed from the photographer. Accordingly, there is little possibility that it is erroneously operated.

In this condition, because the main operation unit 23 is exposed, it is possible to operate it and perform reproduction and display of recorded image data, if necessary. Further, when image data which has been already obtained through photography is transferred to a PC or the like, it is possible to perform a transfer operation while displaying and checking the contents of the image data, in the above-mentioned condition.

On the occasion of photography in the vertical position when the LCD monitor unit 19 is used as the electronic finder, photography is performed in a condition in which the LCD monitor unit 19 is raised, as shown in FIG. 11, the photographer holds the electric camera 10 in a manner such that the objective incidence surface of the photographing lens 14 is faced to a subject for photography, and the strobe-light light-emitting unit 16 is located to the upper left of the objective incidence surface of the photographing lens 14 viewed from the photographer. At this time, it is possible to tilt the LCD screen 22 to a position such that it is easy to view by rotating the LCD screen 22 around the axis perpendicular to the rotation axis of opening/closing of the LCD monitor unit 19, as shown in FIG. 11, depending on a photographing posture and/or a condition of external light.

In this condition, the vertical-position release button 13 is located at a portion of the front surface to the lower right approximately in the center thereof where the index finger of the right hand is naturally located. Accordingly, it is possible to perform photography in the vertical position with the photographer's operations which are not unnatural. At this time, it is preferable that the left hand supports the raised LCD monitor unit 19. Because the photographing operation unit 11 is located in the left surface at the center thereof, the mode operation unit 20 is located in the side surface on this side above the eyepiece of the optical finder 17, and the main operation unit 23 is located in the left surface somewhat to the bottom, any thereof can be easily operated. Also at this time, the horizontal-position release button 12 is located in the left surface viewed from the photographer. Accordingly, there is little possibility that it is erroneously operated.

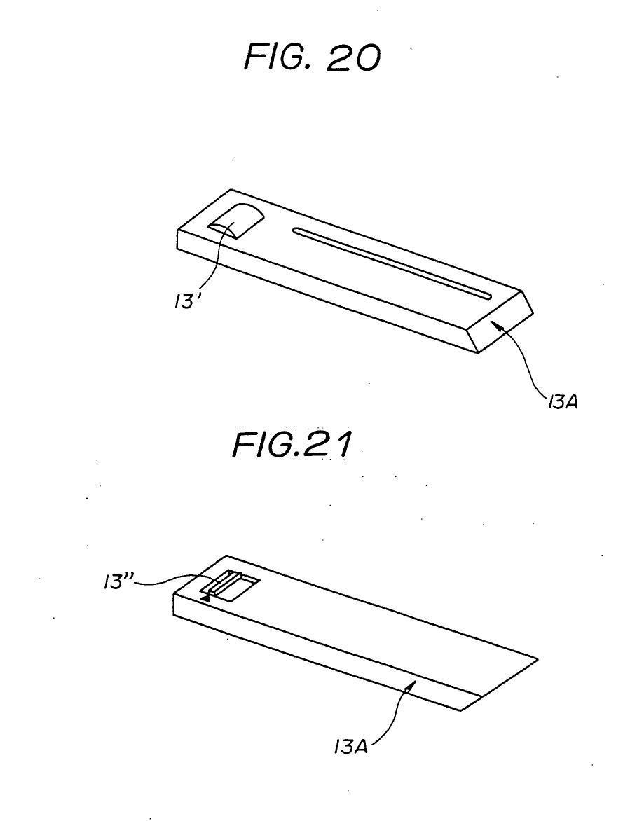

It is possible that a portion including the vertical-position release button 13 and the vicinity thereof is made to be detachable, remote-operation functions for this electronic camera is made to be had by this portion, and, as shown in FIG. 20, a detachable remote control device 13A is thus produced. In this case, a release button 13′ provided in this portion functions as the vertical-position release button in a condition in which the portion is loaded in the camera body, but functions as a remote-control release button in a condition in which this portion is removed from the camera body. It is also possible to provide, other than the release button, an operation unit which corresponds to part or all of the photographing operation unit 11, mode operation unit 20 and main operation unit 23 in the detachable remote-control device 13A. In this case, signal transmitting/receiving units which transmit/receive remote-control signals are provided in both the detachable remote control device 13A and the camera body.

Further, it is also possible that, as shown in FIG. 21, a vertical/horizontal-position instructing operation unit 13″ is provided on the rear surface of the detachable remote control device 13A, and, as a result of a user operating the vertical/horizontal-position instructing operation unit 13″, the information indicating the vertical or horizontal position is transmitted to the camera body.

Further, it is also possible that respective portions including both the horizontal-position release button 12 and vertical-position release button 13 and the respective vicinities thereof are made to be detachable, and remote-operation functions for this electronic camera are made to be had by each of these portions, and, thus, a detachable horizontal-position remote control device and a detachable vertical-position remote control device are thus produced. Then, also at a time of photography through remote control operations, whether the current photograph is of the horizontal position or vertical position is determined from which one of these remote control devices has been used. In this case, a release button provided in the detachable horizontal-position remote control device functions as the horizontal-position release button in a condition in which this remote control device is loaded in the camera body, but functions as a horizontal-position remote-control release button in a condition in which this remote control device is removed from the camera body.

Similarly, a release button provided in the detachable vertical-position remote control device functions as the vertical-position release button in a condition in which this remote-control device is loaded in the camera body, but functions as a vertical-position remote-control release button in a condition in which this remote control device is removed from the camera body. It is possible to provide, other than the release button, an operation unit which corresponds to part or all of the photographing operation unit 11, mode operation unit 20 and main operation unit 23 in each of these remote control devices.

Further, it is also possible that a single detachable remote control device is produced which can be loaded in and removed from, selectively, either one of respective portions including the horizontal-release button 12 and vertical-release button 13 and the respective vicinities thereof.

In this case, a release button provided in this single detachable remote control device is made to function as the horizontal-position release button or vertical-position release button depending on which position the single detachable remote control device is loaded in to be used. In this case, the release button provided in the detachable remote control device functions as the horizontal-position release button or vertical-position release button in a condition in which this device is loaded in the camera body, but functions as a remote-control release button in a condition in which this device is removed from the camera body. In this case, at a time of photography through remote control operations, whether the current photography is of the vertical-position or the horizontal position is not determined. However, it is possible to provide a vertical/horizontal position instructing operation unit in the detachable remote control device, and, thereby, information indicating the vertical or horizontal position is transmitted to the camera body. Alternatively, it is possible to provide a remote-control-signal receiving unit provided in the camera body which can be set to either the horizontal position or vertical position selectively.

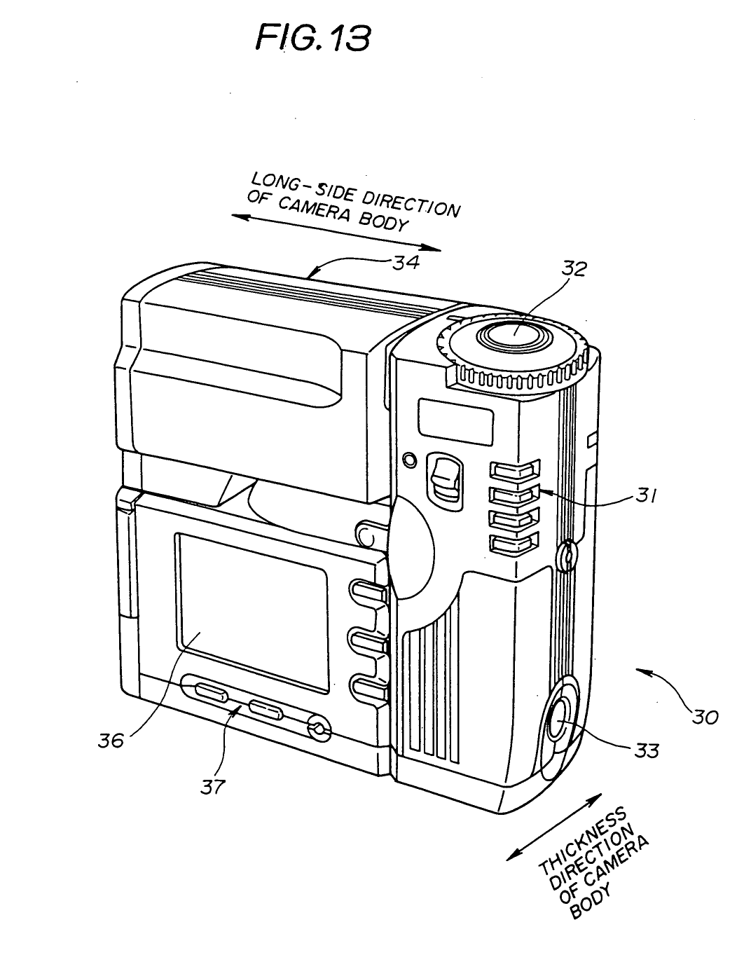

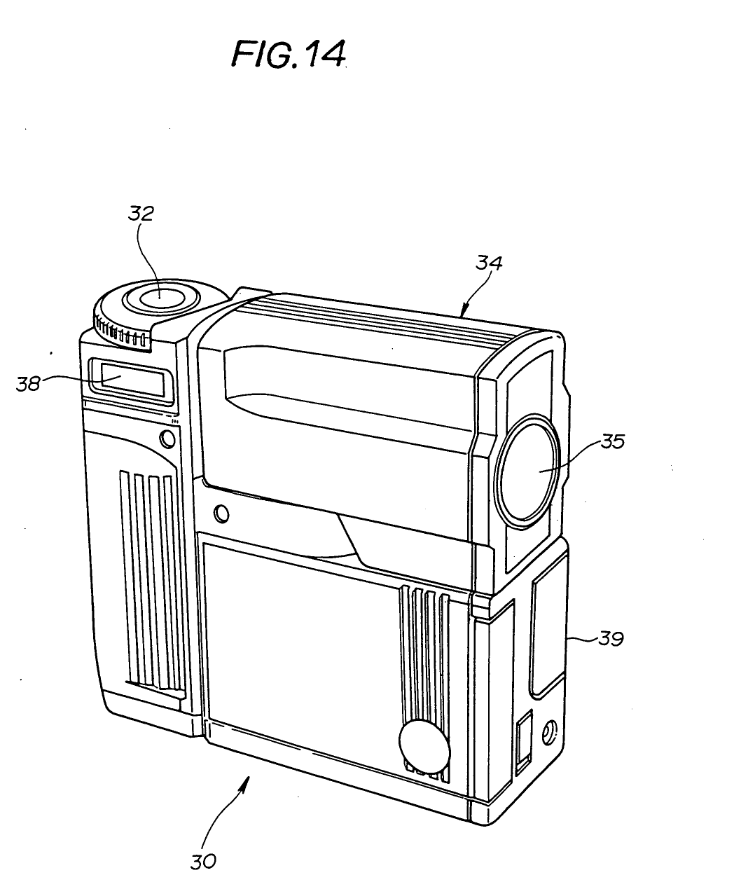

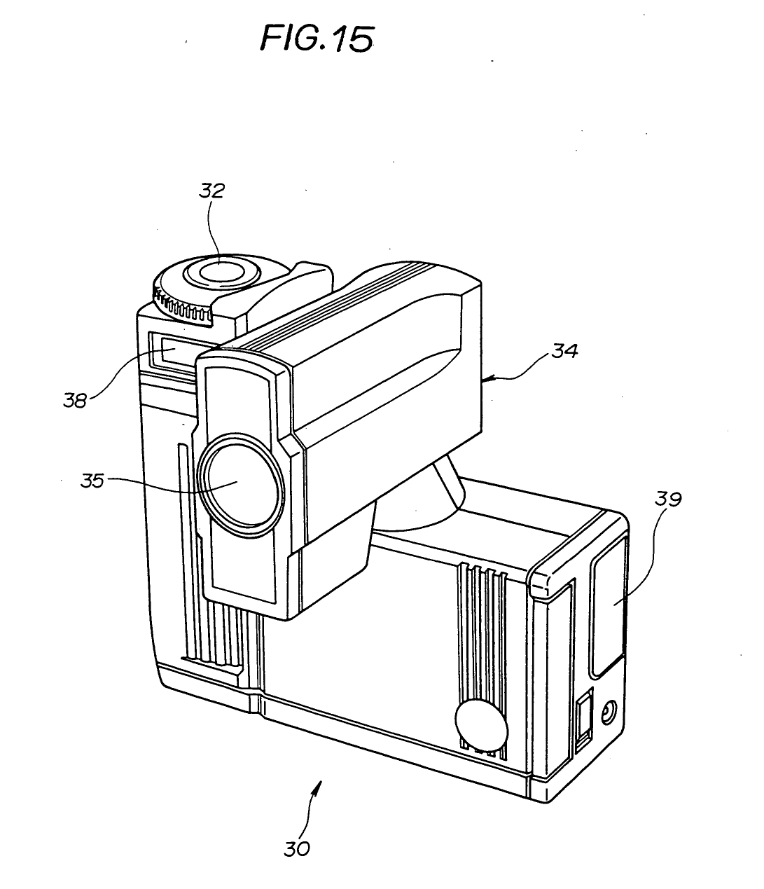

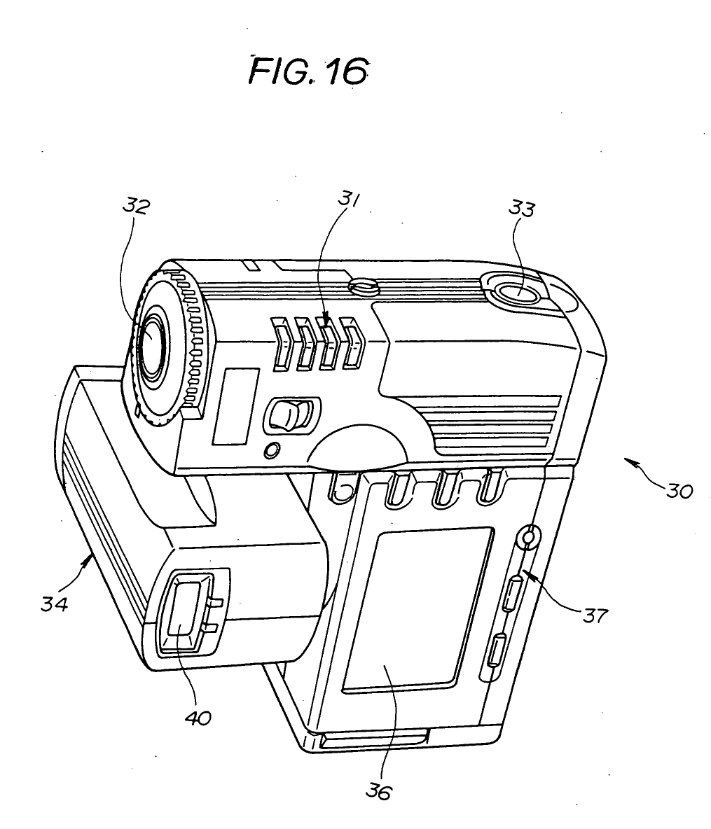

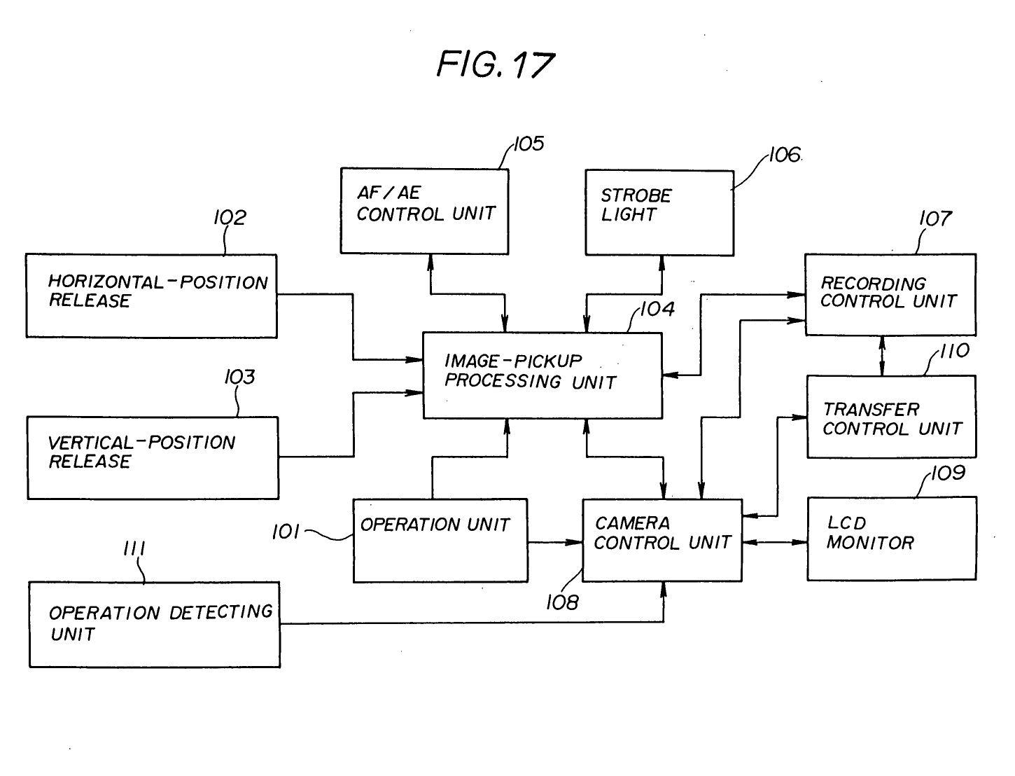

FIGS. 13 through 17 shows a configuration of an electronic camera suitable for photography in the vertical and horizontal positions in a second embodiment of the present invention. FIG. 13 shows a perspective view of the electronic camera in a condition in which a photographing unit is contained in a camera body viewed from a rear side. FIG. 14 shows a perspective view of the electronic camera in the condition in which the photographing unit is contained in the camera body viewed from a front side. FIG. 15 shows a perspective view of the electronic camera in the horizontal position in a condition in which the photographing unit is raised from the camera body viewed from a front side, that is, a side of an incidence surface of a photographing lens. FIG. 16 shows a perspective view of the electronic camera in the vertical position in the condition in which the photographing unit is raised from the camera body viewed from a rear side, that is, a side of an eyepiece of an optical finder and a screen of an LCD monitor. FIG. 17 is a block diagram showing an electronic-circuit system of this electronic camera.

The entirety of a camera body of the electronic camera 30 shown in FIGS. 13 through 17 has a shape like a flat rectangular parallelepiped in the condition in which the photographing unit is contained in the camera body. The electronic camera 30 includes a photographing operation unit 31, a horizontal-position release button 32, a vertical-position release button 33, the photographing unit 34, the photographing lens 35, the LCD screen 36, a main operation unit 37, a strobe-light light-emitting unit 38, a connector unit 39 and the optical finder 40.

The photographing operation unit 31 includes operation buttons and so forth for a photographer to perform therethrough various operations relating to photography, and is provided at a position in a right edge on this side at approximately the center but to the top thereof in the horizontal position viewed from the photographer, such that this unit 31 can be easily operated either in the horizontal position in which the flat camera body having an L-shape viewed from a subject for photography is held by the photographer approximately horizontally in a condition in which the long-side direction of the camera body coincides with the lateral direction and the thickness direction hereof coincides with the forward/backward direction, or in the vertical position in which the camera body is held by the photographer approximately vertically in a condition in which the long-side direction thereof coincides with the vertical direction and the thickness direction thereof coincides with the forward/backward direction.

The horizontal-position release button 32 is located in the top surface of a standing portion of the L-shape in the horizontal position, and can be operated by the index finger of the right hand of a photographer. The vertical-position release button 33 is located in the vicinity of the bottom end of the right side surface in the above-described horizontal position viewed from a photographer, but in the top surface in the vicinity of the right end thereof when the photographer holds the camera body in the vertical position, and, can be operated by the index finger of the right hand when the photographer holds the camera body in the vertical position.

The photographing unit 34 has a configuration such that the photographing lens 35 and optical finder 40 are integrated therein in a manner such that the incidence optical axis of the photographing lens 35 and the optical axis of the eyepiece of the optical finder 40 are parallel to one another, and the incidence surface of the photographing lens 35 and the eyepiece of the optical finder 40 are located in both the end surfaces in the long-side direction thereof, and is supported by approximately the center of the horizontal leg portion of the L-shape in the horizontal position rotatably about an axis perpendicular to these optical axes.

Although not shown in the figures, the photographing unit 34 has a solid image-pickup device and so forth built therein which receives an optical image of a subject for photography formed thereon through the photographing lens 35 and converts it into electronic image information. The photographing unit 34 is contained in the camera body in a manner in which a cut-out portion of the L-shape is filled therewith in a condition in which the above-mentioned optical axes are parallel to the horizontal leg portion of the L-shape in the horizontal position. Thereby, as shown in FIGS. 13 and 14, the entirety including the camera body has the shape like a flat rectangular parallelepiped. Both the ends of the photographing unit 34 project oppositely along the thickness direction of the horizontally long L-shape camera body, as shown in FIGS. 15 and 16, in a condition in which the above-mentioned optical axes are rotated and then are perpendicular to the horizontal leg portion of the L-shape. A range of the rotation of the photographing unit 34 is approximately 90° from the condition shown in FIGS. 13 and 14 to the condition shown in FIGS. 15 and 16. In this case, the objective incidence surface of the photographing lens 35 is exposed in one side surface of the shape like a flat rectangular parallelepiped even in the condition in which the photographing unit 34 is contained in the camera body, and the eyepiece of the optical finder 40 is hidden between the photographing unit 34 and camera body in the condition in which the photographing unit 34 is contained in the camera body.

The LCD screen 36 is the display surface of the LCD used as an electronic finder and for reproducing an image. As shown in FIGS. 13 and 16, the LCD screen 36 is disposed in the surface, at a lower portion thereof, of the electric camera facing the photographer either in the horizontal position or in the vertical position, and is always exposed. The main operation unit 37 is an operation unit for various operations performed by a user such as photography, reproduction and display of recorded image data, and is provided lower than the LCD screen 36 in the horizontal position. The strobe-light light-emitting unit 38 is disposed below and in the vicinity of the horizontal-position release button 32 as shown in FIG. 14. The connector unit 39 has a signal line connected thereto for transmitting/receiving information to/from an external apparatus, for example, transferring image data obtained through photography and stored to an external PC or the like. It is preferable that the connector unit 18 is provided with an openable/closable lid for a dust-proof purpose.

The electronic-circuit system of the above-described electronic camera 30 has the arrangement shown in FIG. 17. In FIG. 17, the same reference numerals are given to units/components having functions approximately the same as those shown in FIG. 12. This electronic-circuit system includes an operation unit 101, a horizontal-position release 102, a vertical-position release 103, an image-pickup processing unit 104, an AF/AE (automatic exposure) control unit 105, a strobe light 106, a recording control unit 107, a camera control unit 108, an LCD monitor 109, a transfer control unit 110 and an operation detecting unit 111.

The operation unit 101 supplies operation information input as a result of the photographing operation unit 31 and main operation unit 37, shown in FIGS. 13 through 16, being operated by a user, to the image-pickup processing unit 104 and camera control unit 108. The horizontal-position release 102 supplies release information input as a result of the horizontal-position release button 32 being operated by a photographer, to the image-pickup processing unit 104 and causes it to perform image pickup in a manner such that image data obtained through the photography is treated as image data of the horizontal position. The vertical-position release 102 supplies release information input as a result of the vertical-position release button 33 being operated by the photographer, to the image-pickup processing unit 104 and causes it to perform image pickup in a manner such that image data obtained through the photography is treated as image data of the vertical position.

In response to the release information supplied from the horizontal release 102 and vertical release 103 in accordance with operations performed by a photographer on the horizontal-position release button 32 and vertical-position release button 33, the image-pickup processing unit 104 causes the AF/AE control unit 105, strobe light 106, recording control unit 107, camera control unit 108 and so forth to operate appropriately based on a photographing mode (mode of image-pickup operations) which is set at the time, and to perform AF and AE control, control of light emitting of the strobe light 106, control of recording image data in a recording medium, and other controls of camera operations appropriately, selectively, as the need arises, and thus, performs image-pickup operations. The image-pickup processing unit 104 obtains image-pickup data as image data of the horizontal position or image data of the vertical position, or processes image data obtained through photography in a manner such that the obtained image data is treated as image data of the horizontal position or image data of the vertical position, in accordance with whether the release information is supplied by the horizontal-position release 102 or vertical-position release 103, that is, whether the horizontal-position release button 32 or vertical-position release button 33 is operated by the photographer.

The AF/AE control unit 105 operates, in conjunction with the image-pickup processing unit 104, and performs AF control based on focusing information obtained from transmitting/receiving the focusing beam in accordance with the active autofocusing, for example. Further, the AF/AE control unit 105 obtains information of quantity of light of the subject for photography from a light-receiving device provided in the optical system such as the photographing lens 35, optical finder 40 and so forth, or provided separately, or an image-pickup device in the image-pickup processing unit 104, and performs proper exposure control based thereon.

The strobe light 106 is controlled by the image-pickup processing unit 104, and operates when it is necessary from an AE-control point of view of the AF/AE control unit 105, or when it is instructed manually through the operation unit 101, and causes the strobe-light light-emitting unit 38 to emit light. The recording control unit 107 writes image data obtained through image pickup by the image-pickup processing unit 104 in the recording medium.

The camera control unit 108 controls the image-pickup processing unit 104 in accordance with the operation information from the operation unit 101, so as to cause it to perform photography, display through the LCD monitor 109 an image of a subject for photography before or on photography, or reproduce and display an image of a subject photographed and stored in the recording medium or the like. The LCD monitor 109 is controlled by the camera control unit 108, displays an image of a subject before or on photography obtained through the image-pickup device of the image-pickup processing unit 104 or displays an image of a subject stored in and reproduced from the recording medium or the like, on the LCD screen 36. Based on control by the camera control unit 108 in accordance with the operation information from the operation unit 101, the transfer control unit 110 reads image data stored in the recording medium through the recording control unit 107, and transfers it selectively or collectively to an external PC or the like.

Even a driving power source is not turned on through the main switch of the operation unit 101 operated by a user, the operation detecting unit 111 controls the camera control unit 108 and turns the driving power source on, in response to the photographing unit 34 being rotated by a user.

Operations and functions of the above-described electronic camera 30 will now be described concretely.

First, when it is carried, in the condition in which the photographing unit 34 is contained in the cut-out portion of the L-shape of the camera body, the electric camera 30 is made to have the shape like a flat rectangular parallelepiped, as shown in FIGS. 13 and 14. In this condition, the electronic camera 30 is not unwieldy and has a few uneven portions. Accordingly, it is very easy to carry.

When photography in the horizontal position is performed, the photographing unit 34 is rotated by 90° so that the objective incidence surface of the photographing lens 35 is faced to a subject for photography. Then, as shown in FIG. 15, the photographer holds the electronic camera 30 in such a manner that the strobe-light light-emitting unit 38 is located to the upper right of the objective incidence surface of the photographing lens 35 viewed from the photographer. At this time, even in a condition in which the driving power source is not turned on through the main switch by the photographer previously, the rotation operation of the photographing unit 34 performed by the photographer is detected by the operation detecting unit 111, the camera control unit 108 is controlled, and, thereby, the driving power source is automatically turned on. The horizontal-position release button 32 is disposed in the top surface of the right end at which the index finger of the right hand is naturally located when the photographer thus holds the electronic camera 30 in the horizontal position. Thereby, it is possible to perform photography in the horizontal position with the photographer's operations which are not unnatural.

When photography in the vertical position is performed, the photographing unit 34 is rotated by 90° so that the objective incidence surface of the photographing lens 35 is faced to a subject for photography. Then, as shown in FIG. 16, the electronic camera 30 in this condition is rotated by 90° about the incidence optical axis of the photographing lens 35, and the photographer holds the electronic camera 30 in such a manner that the strobe-light light-emitting unit 38 is located above the photographing lens 35 viewed from the photographer, and the LCD screen 36 is located on the right side of the photographing unit 34. Through this arrangement, the vertical-position release button 33 is disposed in the top surface of the right end at which the index finger of the right hand is naturally located when the photographer thus holds the electronic camera 30 in the vertical position. Thereby, it is possible to perform photography in the horizontal position with the photographer's operations which are not unnatural.

In photography either in the horizontal position or vertical position, the LCD screen 36 is below or to the right of the eyepiece of the optical finder 40, the LCD screen 36 can be used as the electronic finder as a result of an image in the image-pickup field of view received by the solid image-pickup device being displayed on the LCD screen 36.

Also in this second embodiment, similar to the first embodiment, a portion including at least one of the horizontal-position release button 32 and so forth, and vertical-position release button 33 and so forth, and the vicinity thereof is used as a detachable remote-control device.

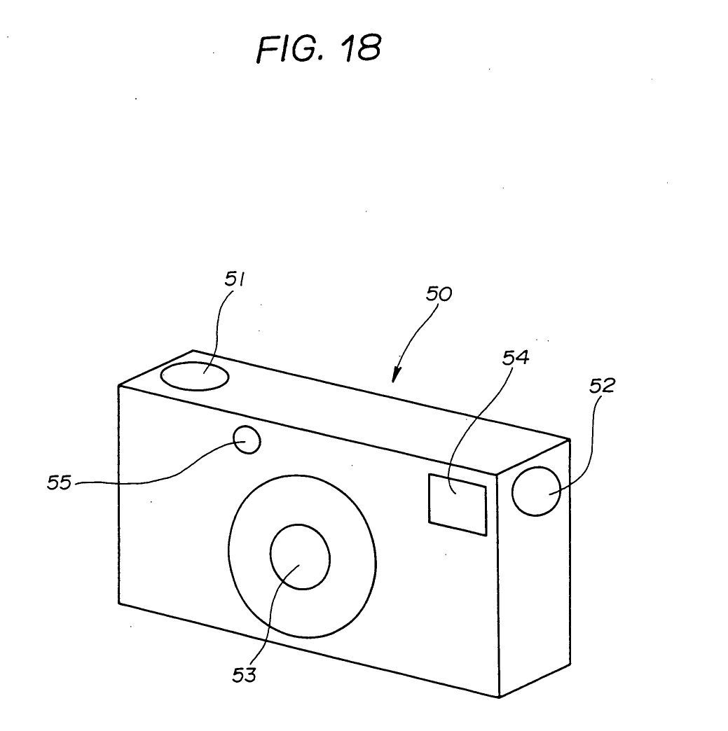

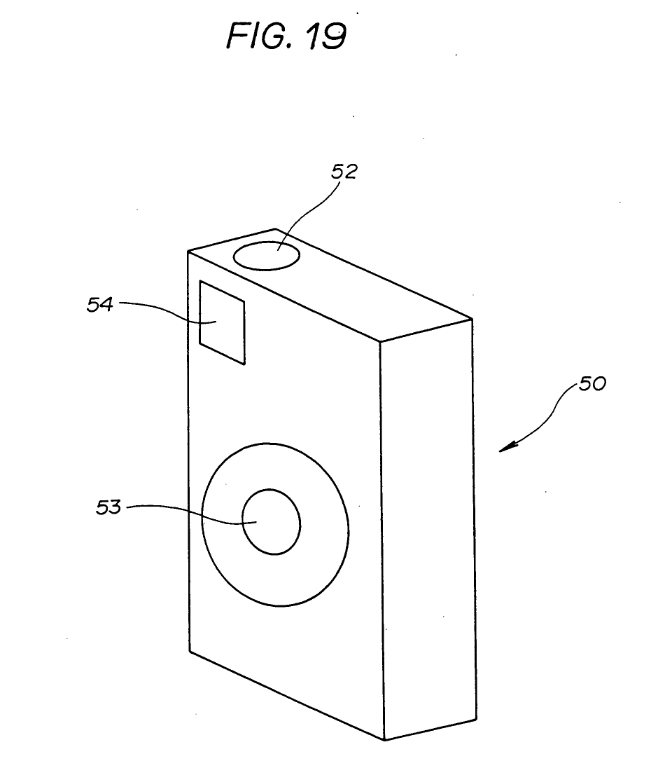

FIGS. 18 and 19 show a configuration of an electronic camera suitable for photography in the vertical and horizontal positions in a third embodiment of the present invention. FIG. 18 shows a perspective view of the electronic camera held in the horizontal position viewed from a front side. FIG. 19 shows a perspective view of the electronic camera held in the vertical position viewed from the front side.

The entirety of a camera body of the electronic camera 50 shown in FIGS. 18 and 19 has a shape like a flat rectangular parallelepiped, and the camera 50 includes a horizontal-position release button 51, a vertical-position release button 52, a photographing lens 53, a strobe-light light-emitting unit 54 and an optical finder 55.

The horizontal-position release button 51 is disposed in the top surface at the right end thereof viewed from a photographer in the horizontal position shown in FIG. 18, and can be easily operated by the index finger of the right hand of the photographer. The vertical-position release button 52 is disposed in the left side surface in the vicinity of the top end thereof viewed from a photographer in the horizontal position shown in FIG. 18. That is, the vertical-position release button 52 is disposed on the top surface in the vicinity of the right end thereof viewed from the photographer when the camera body is held in the vertical position as shown in FIG. 19, and can be easily operated by the index finger of the right hand of the photographer when the photographer holds the electronic camera 50 in the horizontal position.

As shown in FIG. 18, the camera body has the photographing lens 53, strobe-light light-emitting unit 54 and the objective surface of the optical finder 55 disposed in the front surface thereof. The strobe-light light-emitting unit 54 is disposed in the vicinity of the upper-left corner viewed from a photographer in the horizontal position, and is located in the vicinity of the upper-right corner viewed from a photographer in the vertical position.

Also in this third embodiment, similar to the first and second embodiments, a portion including at least one of the horizontal-position release button 51 and so forth, and the vertical-position release button 52 and so forth, and the vicinity thereof is used as a detachable remote-control device.

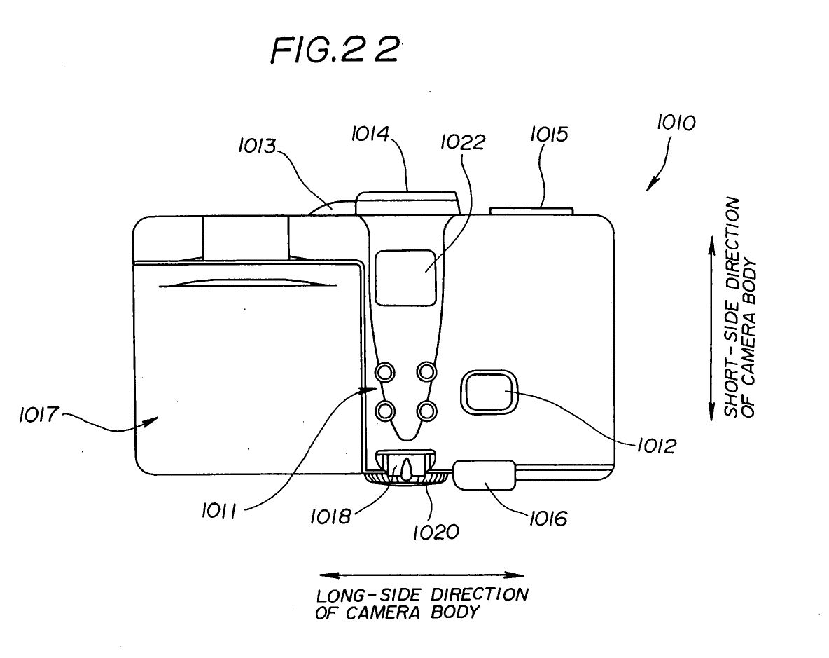

FIGS. 22 through 28 show a configuration of an electronic camera suitable for photography in the vertical and horizontal positions in a fourth embodiment of the present invention.

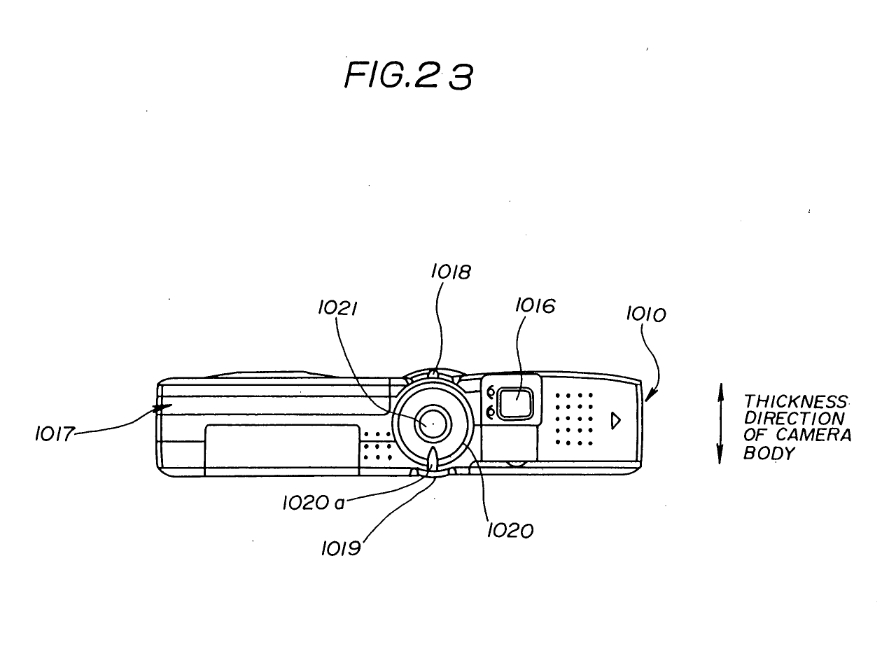

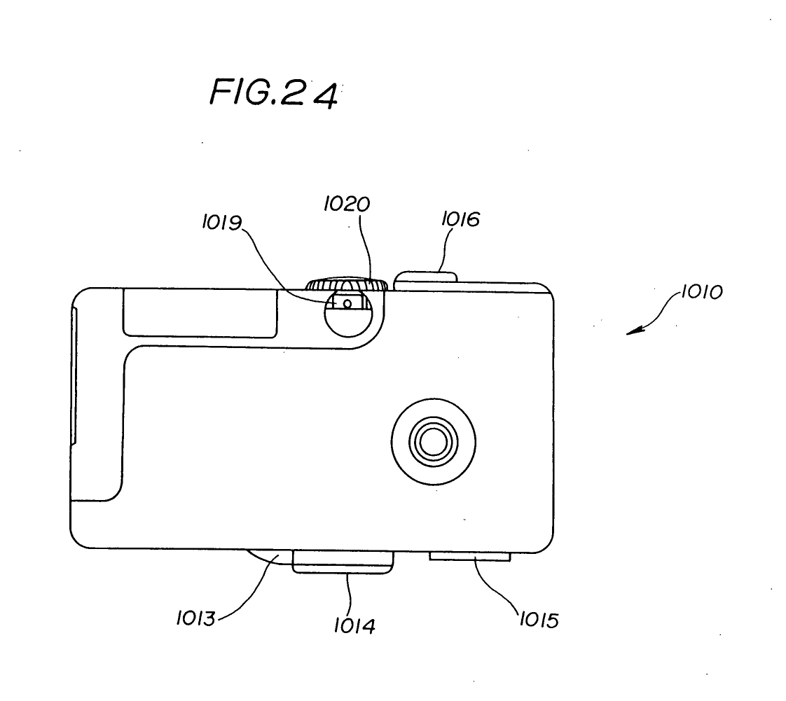

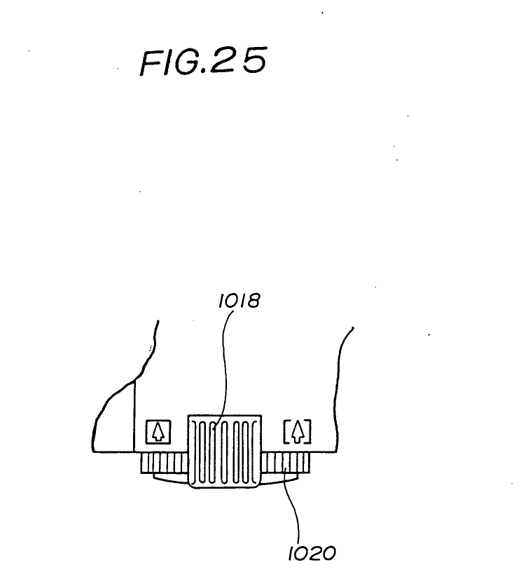

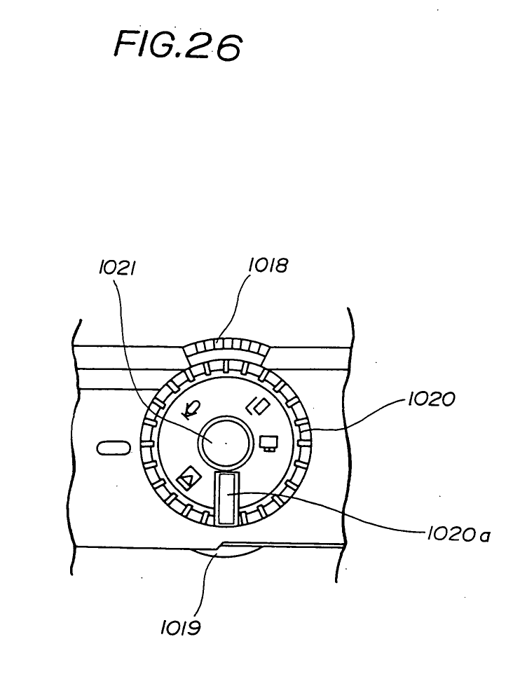

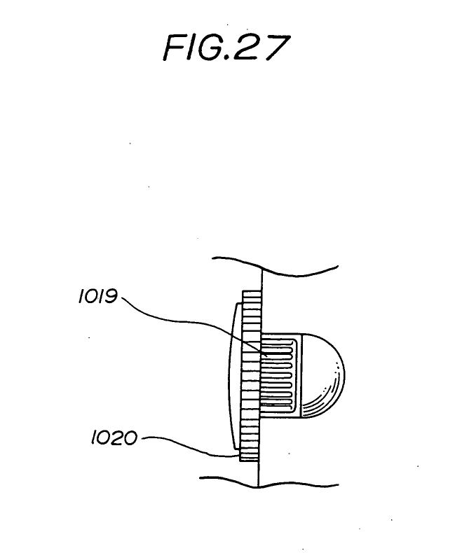

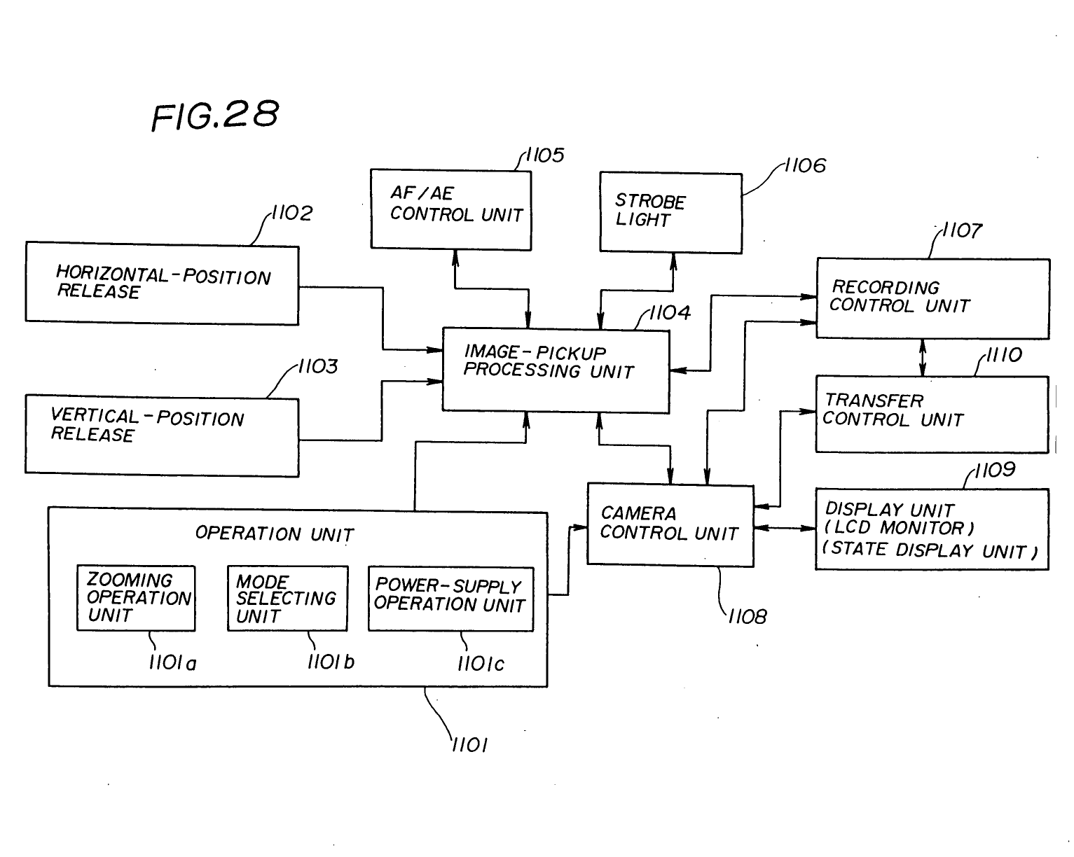

FIG. 22 shows a plan view of the electronic camera in a condition in which a liquid-crystal-display monitor unit (referred to as an ‘LCD monitor unit’, hereinafter) is closed, viewed from a side of a top surface. FIG. 23 shows a rear elevational view of the electronic camera in the condition in which the LCD monitor unit is closed, viewed from a side of an eyepiece of an optical finder. FIG. 24 shows a bottom view of the electronic camera in the condition in which the LCD monitor unit is closed, viewed from a side of a bottom surface. FIG. 25 is a partial detailed view showing a zooming lever of a zooming operation unit, shown in FIG. 22, in detail. FIG. 26 is a partial detailed view of the zooming lever of the zooming operation unit, a mode dial, that is, a mode selecting operation unit and a main switch button, that is, a main switch operation unit, shown in FIG. 23, in detail. FIG. 27 is a partial detailed view showing an auxiliary zooming lever of the zooming operation unit, shown in FIG. 24, in detail. FIG. 28 is a block diagram showing an arrangement of an electronic-circuit system of the electronic camera.

The entirety of a camera body of the electronic camera 1010 shown in FIGS. 22, 23 and 24 has a shape like a flat rectangular parallelepiped, and the camera 1010 includes a photographing operation unit 1011, a horizontal-position release button 1012, a vertical-position release button 1013, a photographing lens 1014, a strobe-light light-emitting unit 1015, the optical finder 1016, the LCD monitor unit 1017, the zooming lever 1018, the auxiliary zooming lever 1019, the mode dial 1020, the main switch 1021, and a state display unit 1022.

The photographing operation unit 1011 includes operation buttons and so forth for a photographer to perform various operations therethrough relating to photography, and is disposed in the top surface approximately at the center thereof in the horizontal position, that is, is disposed in the left side surface in the vertical position viewed from a photographer, so that it can be easily operated by the photographer either in the horizontal position in which the photographer holds the camera body having the shape like a flat rectangular parallelepiped approximately horizontally in a condition in which the long-side direction thereof coincides with the horizontal direction and the thickness direction thereof coincides with the vertical direction, or in the vertical position in which the photographer holds the camera body having the shape like a flat rectangular parallelepiped approximately vertically in a condition in which the long-side direction thereof coincides with the vertical direction and the thickness direction thereof coincides with the horizontal direction.

The horizontal-position release button 1012 is disposed in the top surface of the camera body, approximately at the center thereof but to the right and on the side thereof somewhat far from a subject for photography, in the vicinity of the photographing operation unit 1011, and can be operated by the index finger of the right hand of the photographer. The vertical-position release button 1013 is disposed on the left side of and in the vicinity of the objective incidence surface of the photographing lens 1014 in the above-described horizontal position viewed from the photographer, and, is disposed below and in the vicinity of the photographing lens 1014 so as to be able to be operated by the index finger of the right hand, when the photographer holds the camera body with the right hand in the vertical position.

The photographing lens 1014 is a zoom lens in this case, has the objective incidence surface thereof exposed on one side surface (thickness surface) along the long-side direction of the camera body having the shape of a flat rectangular parallelepiped, and the incidence optical axis thereof is directed in the short-side direction of the camera body.

The strobe-light light-emitting unit 1015 is disposed, in the vicinity of the objective incidence surface of the photographing lens 1014, and, in this case, to the upper right in the horizontal position viewed from the photographer.

The optical finder 1016 has the objective incidence surface (not shown in the figures) thereof exposed on the above-mentioned one side surface along the long-side direction close to the top in the horizontal position between the objective incidence surface of the photographing lens 1014 and the strobe-light light-emitting unit 1015, and has the eyepiece thereof exposed on the other side surface opposite to the above-mentioned one side surface.

The LCD monitor 1017 is provided in a manner such that it can be set in a desired angular position as a result of opening/closing operations being performed as a result of it being rotated around the edge (rotation axis) of the top surface on the side of a subject for photograph in the horizontal position, (similarly to the case shown in FIG. 9), and, in a condition in which it is closed, the display screen thereof comes into contact with the camera body and can be hidden (FIGS. 22, 23 and 24 showing the condition in which the LCD monitor unit 1017 is closed). Further, this LCD monitor unit 1017 is provided in a manner such that, in a condition in which it is raised so as to expose the display screen thereof, (similarly to the case shown in FIG. 11), it can be rotated around an axis perpendicular to the rotation axis of the above-mentioned opening/closing operations. Accordingly, it is possible to move the LCD monitor unit 1017 in a manner such that, in the condition in which the LCD monitor unit 1017 is raised, (similarly to the case shown in FIG. 11), it is rotated around the axis perpendicular to the rotation axis of the opening/closing operations, thus the display screen is reversed, and, thereby, the display screen is exposed on the top surface of the camera body even in a condition in which the LCD monitor unit 1017 is closed.

The zooming lever 1018, auxiliary zooming lever 1019, mode dial 1020 and main switch 1021 are, as shown in FIGS. 25, 26 and 27 in detail, are disposed in the side surface on which the eyepiece of the optical finder 1016 is exposed, and are provided coaxially adjacent to this eyepiece. The zooming lever 1018 and auxiliary zooming lever 1019 are used for performing zooming operations of the photographing lens 1014. As shown in FIGS. 25 and 26, the zooming lever 1018 slightly projects in the vicinity of the eyepiece of the optical finder 1016 from the top surface of the camera body when it is held in a horizontal orientation corresponding to the horizontal position in the standard condition, that is, from the left surface thereof when it is held in a vertical orientation corresponding to the vertical position, and rotates as a result of being operated to slide. The zooming lever 1018 is operated by the index finger of the left hand or the like at a time of photography in the vertical position or at a time of monitoring photography in the horizontal position in a condition in which the LCD monitor unit 1017 is raised and is used as the electronic finder, for example.

As shown in FIGS. 26 and 27, the auxiliary zooming lever 1019 slightly projects in the vicinity of the eyepiece of the optical finder 1016 from the bottom surface of the camera body when it is held in the horizontal orientation corresponding to the horizontal position in the standard condition, that is, from the right surface thereof when it is held in the vertical orientation corresponding to the vertical position, and rotates as a result of being operated to slide. The auxiliary zooming lever 1019 is operated by the thumb of the left hand or the like at a time of photography in the horizontal position in a condition in which the optical finder 1016 is used, for example.

The mode dial 1020 is provided, as shown in FIG. 26, so as to project from the side surface on which the eyepiece of the optical finder 1016 is exposed, and can be rotated about an axis perpendicular this side surface, and a photographer operates so as to rotate it for selecting a mode of image-pickup operations. The circumferential surface and top surface of the mode dial 1020 are made to be uneven, and, the mode dial 1020 can be operated so as to be rotated by the thumb of the right hand or the like of the photographer at a time of photography in the vertical position.

The mode dial 1020 has a projecting line portion 1020a projecting along the downward radial direction in the case of the horizontal position, that is, the rightward radial direction in the case of the vertical position, so that a photographer can recognize, even at night or the like, that the mode dial 1020 is in a rotation position in a standard setting condition such as that of a normal photographing mode or the like. As shown in FIG. 26, the main switch 1021 is a pushbutton switch provided in a position corresponding to the center of and the rotation-axis-center position of the mode dial 1020, and, the main power source is turned on and off in a toggle manner as a result of being pressed repeatedly by a photographer. The zooming lever 1018 and auxiliary zooming lever 1019 are provided behind the mode dial 1020, are operated so as to be rotated about the axis the same as that of the mode dial 1020 by a photographer. The photographer operates so as to rotate the zooming lever 1018 or auxiliary zooming lever 1019 for performing the zooming operations.

The state display unit 1022 is a liquid-crystal display which performs a display in a segment/pattern display manner simpler than that of the LCD monitor unit 1017, for example. The state display unit 1022 is used for displaying photographing states such as a photographing mode state, a power-source state, whether or not the electronic camera 1010 is in a strobe-light light-emitting mode, a photographing frame number and so forth. The state display unit 1022 is disposed in the vicinity of the photographing operation unit 1011, that is, approximately in the center of the top surface in the horizontal position, that is, the left side surface in the vertical position viewed from the photographer, at a portion close to a subject for photography.

The electronic-circuit system of the above-described electronic camera 1010 has an arrangement shown in FIG. 28. This electronic-circuit system includes an operation unit 1101, a horizontal-position release 1102, a vertical-position release 1103, an image-pickup processing unit 1104, an AF (autofocusing)/AE (automatic exposure) control unit 1105, a strobe light 1106, a recording control unit 1107, a camera control unit 1108, a display unit 1109 and a transfer control unit 1110.

The operation unit 1101 supplies operation information input as a result of the photographing operation unit 1011, zooming lever 1018, auxiliary zooming lever 1019, mode dial 1020 and main switch 1021, shown in FIGS. 22 through 27, being operated by a user, to the image-pickup processing unit 1104 and camera control unit 1108. For this purpose, the operation unit 1101 includes a zooming operation unit 1101a which processes operation information input through the zooming lever 1018 and auxiliary zooming lever 1019, a mode selecting unit 1101b which processes operation information input through the mode dial 1020 and a power-source operation unit 1101c which processes operation information input through the main switch 1021.

The horizontal-position release 1102 supplies release information input as a result of the horizontal-position release button 1012 being operated by a photographer, to the pickup processing unit 1104 and causes it to perform image pickup in a manner such that image data obtained through photography is treated as image data of the horizontal position. The vertical-position release 1102 supplies release information input as a result of the vertical-position release button 1013 being operated by a photographer, to the image-pickup processing unit 1104 and causes it to perform image pickup in a manner such that image data obtained through photography is treated as image data of the vertical position.

In response to the release information supplied from the horizontal release 1102 and vertical release 1103 in accordance with operations performed by a photographer on the horizontal-position release button 1012 and vertical-position release button 1013, the image-pickup processing unit 1104 causes the AF/AE control unit 1105, strobe light 1106, recording control unit 1107, camera control unit 1108 and so forth to operate appropriately based on the photographing mode (mode of image-pickup operations) which is set at the time, and to perform AF and AE control, control of light emitting of the strobe light 1106, control of recording image data in a recording medium, and other controls of camera operations appropriately, selectively, as the need arises, and thus, performs image-pickup operations. The image-pickup processing unit 1104 obtains image-pickup data as image data of the horizontal position or image data of the vertical position, or processes image data obtained through photography in a manner such that the image data is treated as image data of the horizontal position or image data of the vertical position, in accordance with whether the release information is supplied by the horizontal-position release 1102 or vertical-position release 1103, that is, whether the horizontal-position release button 1012 or vertical-position release button 1013 is operated by the photographer.

The AF/AE control unit 1105 operates, in conjunction with the image-pickup processing unit 1104, and performs AF control based on focusing information obtained from transmitting/receiving the focusing beam through an AF window (not shown in the figures) in accordance with the active autofocusing, for example. Further, the AF/AE control unit 1105 obtains information of quantity of light of the subject for photography from a light-receiving device provided in the optical system such as the photographing lens 1014, optical finder 1016 and so forth, or provided separately, or an image-pickup device in the image-pickup processing unit 1104, and performs proper exposure control based thereon.

The strobe light 1106 is controlled by the image-pickup processing unit 1104, and operates when it is necessary from an AE-control point of view of the AF/AE control unit 1105, or when it is instructed manually through the operation unit 1101, and causes the strobe-light light-emitting unit 1015 to emit light.

The recording control unit 1107 writes image data obtained through image pickup by the image-pickup processing unit 1104 in the recording medium. The camera control unit 1108 controls the image-pickup processing unit 1104 in accordance with the operation information from the operation unit 1101, so as to cause it to perform photography, to display, through the LCD monitor unit 1017 of the LCD monitor 1109, an image of a subject for photography before or on photography, or to reproduce and display an image of a subject photographed and stored in the recording medium or the like. The display unit 1109 is controlled by the camera control unit 1108, displays an image of a subject before or on photography obtained through the image-pickup device of the image-pickup processing unit 1104 or displays an image of a subject stored in and reproduced from the recording medium or the like through the recording control unit 1107, on the screen of the LCD monitor unit 1017.

Based on the states of the image-pickup processing unit 1104 and camera control unit 1108, under control by the camera control unit 1108, the display unit 1109 displays information of the state of photographing mode (mode of image-pickup operations), the operating mode of the strobe light 1106 and the state of voltage of a power-supply battery (not shown in the figure), on the screen of the state display unit 1022.

Based on control by the camera control unit 1108 in accordance with the operation information from the operation unit 1101, the transfer control unit 1110 reads image data stored in the recording medium through the recording control unit 1107, and transfers it selectively or collectively to an external PC or the like.

Operations and functions of the above-described electronic camera 1010 will now be described concretely.

First, when it is carried, as shown in FIGS. 22, 23 and 24, the LCD monitor unit 1017 is closed in a condition in which the screen thereof faces inwardly, so that it has the shape like a flat rectangular parallelepiped. In this condition, the electronic camera 1010 is not unwieldy and has a few uneven portions. Accordingly, it is very easy to carry, and, also, the screen of the LCD monitor unit 1017 and so forth are positively protected. When photography is performed only through the optical finder 1016 without employing an electronic finder of the LCD monitor unit 1017, it is possible to perform photography by turning on the main switch 1021 in this condition.

When performing photography in the horizontal position, the photographer holds the electronic camera 1010 horizontally in such a manner that the objective incidence surface of the photographing lens 1014 is faced to a subject for photography, the strobe-light light-emitting unit 1015 is located to the upper right of the objective incidence surface of the photographing lens 1014 viewed from the photographer, and the LCD monitor unit 1017 is located in the top surface, as shown in FIG. 22. In this condition, the horizontal-position release button 1012 is located at a portion of the top surface somewhat on this side and to the right in the center thereof where the index finger of the right hand is naturally located. Therefore, it is possible to perform photography in the horizontal position with the photographer's operations which are not unnatural. At this time, because the photographing operation unit 1011 is located in the top surface at the center thereof, it is easy for the photographer to operate. Further, at this time, because the zooming lever 1018, auxiliary zooming lever 1019, mode dial 1020 and main switch 1021 are located in the side surface on this side to the left of and beside the eyepiece of the optical finder 1016, any thereof can be easily operated by the photographer. Further, at this time, the vertical-position release button 1013 is located on the subject-side side surface on the left side of the photographing lens 1014 viewed from the photographer. Accordingly, there is little possibility that it is erroneously operated.

On the occasion of photography in the vertical position, the photographer holds the electric camera 1010 vertically in a manner such that the objective incidence surface of the photographing lens 1014 is faced to a subject for photography, the strobe-light light-emitting unit 1015 is located to the upper left of the objective incidence surface of the photographing lens 1014 viewed from the photographer, and the LCD monitor unit 1017 is located in the left surface. In this condition, the vertical-position release button 1013 is located at a portion of the front surface to the lower right approximately in the center thereof where the index finger of the right hand which holds the camera body is naturally located. Accordingly, it is possible to perform photography in the vertical position with the photographer's operations which are not unnatural. At this time, it is preferable that the left hand holds the top surface and the left edge thereof of the electronic camera 1010. Because the photographing operation unit 1011 is located in the left surface at the center thereof, the zooming lever 1018, mode dial 1020 and main switch 1021 are located on the side surface on this side below the eyepiece of the optical finder 1016, any thereof can be easily operated by the photographer. The horizontal-position release button 1012 is located in the left surface viewed from the photographer. Accordingly, there is little possibility that it is erroneously operated.

On the occasion of photography in the horizontal position when the LCD monitor unit 1017 is used as the electronic finder, photography is performed in a condition in which the LCD monitor unit 1017 is raised. At this time, it is possible to tilt the screen thereof to a position such that it is easy to view, depending on a photographing posture and/or a condition of external light. Similarly to the above-described condition in which the LCD monitor unit 1017 is closed, the photographer holds the electronic camera 1010 horizontally in such a manner that the objective incidence surface of the photographing lens 1014 is faced to a subject for photography, the strobe-light light-emitting unit 1015 is located to the upper right of the objective incidence surface of the photographing lens 1014 viewed from the photographer, and the LCD monitor unit 1017 is located in the top surface. Also in this condition, the horizontal-position release button 1012 is located at a portion of the top surface somewhat on this side and to the right in the center thereof where the index finger of the right hand is naturally located. Therefore, it is possible to perform photography in the horizontal position with the photographer's operations which are not unnatural.

At this time, because the photographing operation unit 1011 is located in the top surface at the center thereof, and the zooming lever 1018., auxiliary zooming lever 1019, mode dial 1020 and main switch 1021 are located on the side surface on this side to the left of and beside the eyepiece of the optical finder 1016, any thereof can be easily operated.

On the occasion of photography in the vertical position when the LCD monitor unit 1017 is used as the electronic finder, photography is performed in a condition in which the LCD monitor unit 1017 is raised, the photographer holds the electric camera 1010 in a manner such that the objective incidence surface of the photographing lens 1014 is faced to a subject for photography, and the strobe-light light-emitting unit 1015 is located to the upper left of the objective incidence surface of the photographing lens 1014 viewed from the photographer. At this time, it is possible to tilt the screen of the LCD monitor unit 1017 to a position such that it is easy to view by rotating the screen thereof around the axis perpendicular to the rotation axis of opening/closing of the LCD monitor unit 1017, depending on a photographing posture and/or a condition of external light.

In this condition, the vertical-position release button 1013 is located at a portion of the front surface to the lower right approximately in the center thereof where the index finger of the right hand is naturally located. Accordingly, it is possible to perform photography in the vertical position with the photographer's operations which are not unnatural. At this time, it is preferable that the left hand supports the raised LCD monitor unit 1017. Because the photographing operation unit 1011 is located in the left surface at the center thereof, and the zooming lever 1018, auxiliary zooming lever 1019, mode dial 1020 and main switch 1021 are located on the side surface on this side below the eyepiece of the optical finder 1016, any thereof can be easily operated by the photographer.

The present invention is not limited to the above-described embodiments, and variations and modifications may be made without departing from the scope of the present invention.

The present application is based on Japanese priority application Nos. 11-206932 and 11-206933, each filed on Jul. 21, 1999, the entire contents of which are hereby incorporated by reference.

1. An electronic camera suitable for photography in a vertical position and in a horizontal position comprising:
a photographing optical system forming an optical image of a subject for photography;
an image-pickup device performing pickup of the thus-formed optical image of the subject for photography;
an image-pickup processing unit performing appropriate processing on image data of the optical image of the subject for photography taken through said image-pickup device; and
a camera body containing said photographing optical system, image-pickup device and image-pickup processing unit,
wherein:
said electronic camera has at least one release button disposed in at least one of such positions of said camera body that, when said camera body is held either in the horizontal position such that an image-pickup frame is horizontally long or in the vertical position such that an image-pickup frame is vertically long, said release button is easy to operate in respective cases;
said image-pickup processing unit treats the image data as one of that of the image of the vertical position and that of the image of the horizontal position determined based on the position of the release button operated; and
said at least one release button comprises a horizontal-position release button operated when said camera body is held in the horizontal position and a vertical-position release button operated when said camera body is held in the vertical position; and
further comprising a detachable remote-control device which has a release button operatable in a condition in which said device is loaded in said camera body, and can be loaded in and removed from said camera body, so that said device can be loaded in a position such that said release button is easy to operate when said camera body is held in the vertical position, and said release button of said detachable remote-control device is used as said vertical-position release button.

2-5. (Canceled).

6. The electronic camera as claimed in claim 1, wherein said camera body has a shape like a flat rectangular parallelepiped, has an objective surface of a photographing lens on a thickness surface at one end thereof in a short-side direction and an eyepiece of an optical finder on a thickness surface at the other end, and, has said horizontal-position release button of said at least one release button for photography in the horizontal position in a flat top surface, and said vertical-position release button of said at least one release button for photography in the vertical position in said thickness surface at said one end in said short-side direction in the vicinity of said objective surface of said photographing lens.

7. The electronic camera as claimed in claim 1, wherein said camera body has a shape like a flat rectangular parallelepiped, has an objective surface of a photographing lens on a thickness surface at one end thereof in a short-side direction and an eyepiece of an optical finder on a thickness surface at the other end, has a display unit in a flat top surface, which is rotatable so as to be openable/closable around an edge on said one end in said short-side direction used as an axis of the rotation, also rotatable around a perpendicular axis of the rotation provided in the vicinity of the center of the axis of the opening/closing rotation, and can be used as an electronic finder.

8-14. (Canceled).

15. An electronic camera suitable for photography in a vertical position and in a horizontal position comprising:
a photographing optical system forming an optical image of a subject for photography;
an image-pickup device performing pickup of the thus-formed optical image of the subject for photography;
an image-pickup processing unit performing appropriate processing on image data of the optical image of the subject for photography taken through said image-pickup device;
a camera body containing said photographing optical system, image-pickup device and image-pickup processing unit,
wherein:
said electronic camera has at least one release button disposed in at least one of such positions of said camera body that, when said camera body is held either in the horizontal position such that an image-pickup frame is horizontally long or in the vertical position such that an image-pickup frame is vertically long, said release button is easy to operate in respective cases; and
said image-pickup processing unit treats the image data as one of that of the image of the vertical position and that of the image of the horizontal position determined based on the position of the release button operated; and
further comprising a detachable remote-control device which has a release button operatable in a condition in which said device is loaded in said camera body and can be loaded in and removed from said camera body, so that said device can be loaded in said camera body selectively either in a position such that said release button is easy to operate when said camera body is held in the vertical position or in a position such that said release button is easy to operate when said camera body is held in the horizontal position,
said image-pickup processing unit treating the image data as one of that of the image of the vertical position and that of the image of the horizontal position determined based on the position in which said detachable remote-control device is loaded in said camera body.

16. The electronic camera as claimed in claim 15, wherein said at least one release button comprises a horizontal-position release button operated when said camera body is held in the horizontal position and a vertical-position release button operated when said camera body is held in the vertical position.

17. An electronic camera suitable for photography in a vertical position and in a horizontal position comprising:
a photographing optical system forming an optical image of a subject for photography;
an image-pickup device performing pickup of the thus-formed optical image of the subject for photography;
an image-pickup processing unit performing appropriate processing on image data of the optical image of the subject for photography taken through said image-pickup device;
a camera body containing said photographing optical system, image-pickup device and image-pickup processing unit,
wherein:
said electronic camera has at least one release button disposed in at least one of such positions of said camera body that, when said camera body is held either in the horizontal position such that an image-pickup frame is horizontally long or in the vertical position such that an image-pickup frame is vertically long, said release button is easy to operate in respective cases; and
said image-pickup processing unit treats the image data as one of that of the image of the vertical position and that of the image of the horizontal position determined based on the position of the release button operated; and
further comprising:
a detachable horizontal-position remote-control device which has a release button operatable in a condition in which said device is loaded in said camera body, and can be loaded in and removed from said camera body, so that said device can be loaded in said camera body in a position such that said release button is easy to operate when said camera body is held in the horizontal position; and
a detachable vertical-position remote-control device which has a release button operatable in a condition in which said device is loaded in said camera body, and can be loaded in and removed from said camera body, so that said device can be loaded in said camera body in a position such that said release button is easy to operate when said camera body is held in the vertical position,
said image-pickup processing unit treating the image data as either one of that of the image of the vertical position and that of the image of the horizontal position determined based on the detachable remote-control device operated on the occasion of a remote control operation.

18. The electronic camera as claimed in claim 17, wherein said at least one release button comprises a horizontal-position release button operated when said camera body is held in the horizontal position and a vertical-position release button operated when said camera body is held in the vertical position.
